(19) United States
(12) Patent Application Publication
(10) Pub. No.: US 2025/0072696 A1
(43) Pub. Date: Mar. 6, 2025

(54) CLEANING DEVICE

(71) Applicant: SHENZHEN CURIOSITY EXPLORATION TECHNOLOGY CO., LTD., Shenzhen (CN)

(72) Inventors: Zeyu FAN, Shenzhen (CN); Zezhou FAN, Shenzhen (CN); Yao LI, Shenzhen (CN)

(73) Assignee: SHENZHEN CURIOSITY EXPLORATION TECHNOLOGY CO., LTD., Shenzhen (CN)

(21) Appl. No.: 18/953,137

(22) Filed: Nov. 20, 2024

Related U.S. Application Data
(63) Continuation of application No. PCT/CN2022/126943, filed on Oct. 24, 2022.

(30) Foreign Application Priority Data
May 20, 2022 (WO) PCT/CN2022/094264
May 20, 2022 (WO) PCT/CN2022/094265
May 20, 2022 (WO) PCT/CN2022/094266
May 20, 2022 (WO) PCT/CN2022/094267
May 20, 2022 (WO) PCT/CN2022/094268
May 20, 2022 (WO) PCT/CN2022/094269
May 20, 2022 (WO) PCT/CN2022/094270
May 20, 2022 (WO) PCT/CN2022/094271
May 20, 2022 (WO) PCT/CN2022/094272

(51) Int. Cl. A47L 11/40; F26B 5/14

(52) U.S. Cl. CPC A47L 11/4047; A47L 11/4013; A47L 11/4044; A47L 11/4069; F26B 5/14

(57) ABSTRACT

A cleaning device for cleaning a surface, a control method, a control unit, and a computer readable storage medium thereof are disclosed. The cleaning device includes a container, a main cleaning component having a first rotatable conveyor belt, and a guiding component in front of the main cleaning component along a moving direction of the cleaning device. The guiding component includes a second rotatable conveyor belt. The first and second conveyor belts rotate in opposite directions to remove an object from the surface and move the object toward the container when the cleaning device reaches the object on the surface.

### CROSS-REFERENCE TO RELATED APPLICATIONS

This application is a Continuation of International Application No. PCT/CN2022/126943, filed on Oct. 24, 2022, claims priority to PCT/CN2022/094264, filed on May 20, 2022, International Patent Application Serial No. PCT/CN2022/094265, filed on May 20, 2022, International Patent Application Serial No. PCT/CN2022/094266, filed on May 20, 2022, International Patent Application Serial No. PCT/CN2022/094267, filed on May 20, 2022, International Patent Application Serial No. PCT/CN2022/094268, filed on May 20, 2022, International Patent Application Serial No. PCT/CN2022/094269, filed on May 20, 2022, International Patent Application Serial No. PCT/CN2022/094270, filed on May 20, 2022, International Patent Application Serial No. PCT/CN2022/094271, filed on May 20, 2022, International Patent Application Serial No. PCT/CN2022/094272, filed on May 20, 2022, the contents of each of which are hereby incorporated by reference.

### TECHNICAL FIELD

The present disclosure relates to the field of cleaning equipment and more particularly to a cleaning device, a control method, a control unit, and a computer readable storage medium of such cleaning device.

### BACKGROUND OF THE INVENTION

A cleaning device, such as a sweeping device, a mopping device, a vacuum cleaner, etc., are generally defined to perform one function, such as sweeping, mopping, or vacuum-cleaning. A sweeping-cleaning apparatus typically transfers garbage on a surface to an internal container through a rotating elongated roller brush or a rotating elongated double-roller assembly. A vacuum-cleaning apparatus applies the suction power (e.g., of a fan) to remove garbage off a surface. A mopping-cleaning apparatus typically absorbs liquid off the surface using, for example, one or more mopping discs or elongated rollers that may include some type of absorptive materials (e.g., fleece, cotton-polymer hybrid, etc.) wrapped around the mopping discs or rollers. Some modern mopping-cleaning devices may use the suction power (e.g., of a fan) to better dry the surface and/or to transfer liquid off the surface to a container.

In other related cleaning devices (e.g., commercial cleaners, etc.), a disk brush may be used to sweep a surface while another scraper (or mopping) apparatus may be used to clean/dry the surface. The above example cleaning apparatuses, however, may generate loud and unpleasant noises (e.g., due to the deployment of air blowing/suction engines), create high power consumption, and/or require high maintenance costs (e.g., due to main engine, filter(s), or other parts' replacement requirements).

Additionally, customary cleaning devices may not be able to clean the surface from relatively small or large sizes garbage (e.g., dust and small particles, a sheet of paper, a large and crumbled up paper/board, etc.) due to their structure and/or design. Moreover, the traditional cleaning devices with, for example, elongated rollers or roller brushes are prone to be entangled with elongated objects (e.g., human and/or pet hair, loose pieces of strings, etc.), while the other cleaning devices with, for example, roller brushes, mopping discs, or disk brushes are prone to jamming due to the mere size of the garbage (e.g., such as a crumbled up paper or any other relatively large object) which may result in the garbage getting stuck in the roller brushes, mopping discs, or disk brushes.

The above described shortcomings in the currently used cleaning devices necessitate additional improvements in the structure and design of the cleaning devices to increase the smoothness and efficiency in a cleaning experience. For example, effectively cleaning a surface from both solid and liquid waste using a single device during a single sweep is highly desirable.

### SUMMARY

AsAs discussed above, the present disclosure is directed to a cleaning device, a control method, a control unit, and a computer readable storage medium of such cleaning device.

In a first aspect of the present disclosure, a cleaning device for cleaning a surface is provided. The cleaning device includes a container, a main cleaning component including a first rotatable conveyor belt, and a guiding component in front of the main cleaning component along a moving direction of the cleaning device. The guiding component includes a second rotatable conveyor belt. The first and second conveyor belts rotate in opposite directions to remove an object from the surface and move the object toward the container when the cleaning device reaches the object on the surface.

In an embodiment of the first aspect, the object includes at least one of liquid garbage and solid garbage.

In another embodiment of the first aspect, the cleaning device is moved in different directions using an external force.

In another embodiment of the first aspect, the external force includes at least one of a driving engine and a handheld unit.

In another embodiment of the first aspect, the first conveyor belt rotates clockwise while the second conveyor belt rotates counterclockwise.

In another embodiment of the first aspect, the main cleaning component further includes at least one roller and at least one plane forming member. The at least one roller and the at least one plane forming member are spaced apart laterally or spaced apart from each other along a height of the cleaning device, the first conveyor belt rotatably surrounds the at least one roller and the at least one plane forming member.

In another embodiment of the first aspect, the guiding component further includes at least one roller and at least one plane forming member. The at least one roller and the at least one plane forming member are spaced apart laterally or spaced apart from each other along a height of the cleaning device. The second conveyor belt rotatably surrounds the at least one roller and the at least one plane forming member.

In another embodiment of the first aspect, the at least one plane forming member includes two plane forming members that cause a bottom portion of the first conveyor belt near the surface to form a plane that presses against the surface. The at least one roller is positioned above the two plane forming members along the height of the cleaning device.

In another embodiment of the first aspect, the at least one plane forming member includes a plane forming member that causes a bottom portion of the first conveyor belt near the surface to form a plane that presses against the surface. The plane forming member includes a plate and two arc-like members positioned at opposite ends of the plate.

In another embodiment of the first aspect, the at least one plane forming member includes three plane forming members. The at least one roller includes a roller. The roller and two of the three plane forming members are positioned within the first conveyor belt and one of the three plane forming member is positioned outside the first conveyor belt. The roller and the two plane forming members are spaced apart such that to cause a bottom portion of the first conveyor belt near the surface to form a plane that presses against the surface. The one plane forming member outside the first conveyor belt is positioned such that to cause a recess in one side of the first conveyor belt.

In another embodiment of the first aspect, the roller and the three plane forming members form the first conveyor belt as an ‘L’ shape.

In another embodiment of the first aspect, the roller is positioned above the three plane forming members.

In another embodiment of the first aspect, the roller and one of the plane forming members are at two opposite ends of the plane.

In another embodiment of the first aspect, the at least one plane forming member includes two plane forming members. The at least one roller includes a roller. The roller and the two plane forming members are positioned within the conveyor belt. The roller and the two plane forming members are spaced apart such that to cause a bottom portion of the conveyor belt near the surface to form a plane that presses against the surface. The container is positioned over the plane along a height of the cleaning device such that to cause a recess in one side of the conveyor belt.

In another embodiment of the first aspect, the roller, the two plane forming members, and the container form the first conveyor belt as an ‘L’ shape.

In another embodiment of the first aspect, a roller in the at least one roller is positioned above the at least one plane forming member along the height of the cleaning device.

In another embodiment of the first aspect, at least one of the at least one plane forming member is positioned above the at least one roller along the height of the cleaning device.

In another embodiment of the first aspect, the at least one plane forming member includes two plane forming members that are spaced apart laterally. The at least one roller is positioned above the two plane forming members along the height of the cleaning device.

In another embodiment of the first aspect, the two plane forming members and the at least one roller form the second conveyor belt as a triangular shape.

In another embodiment of the first aspect, the at least one plane forming member includes two plane forming members. The two plane forming members are positioned within the second conveyor belt below the at least one roller such that the two plane forming members cause a first portion of the second conveyor belt near the surface to form an induction slope for guiding the object toward the first conveyor belt, or cause a second portion of the second conveyor belt near the surface to form a plane to press against the surface.

In another embodiment of the first aspect, the main cleaning component further includes at least one first roller and at least one first plane forming member. The at least one first roller and the at least one first plane forming member are spaced apart laterally or spaced apart from each other along a height of the cleaning device. The first conveyor belt rotatably surrounds the at least one first roller and the at least one first plane forming member. The guiding component further includes at least one second roller and at least one second plane forming member. The at least one second roller and the at least one second plane forming member are spaced apart laterally or spaced apart from each other along the height of the cleaning device. The second conveyor belt rotatably surrounds the at least one second roller and the at least one second plane forming member.

In another embodiment of the first aspect, the cleaning device further includes at least one control unit configured to rotate the at least one first roller thereby causing the first conveyor belt to rotate in a first direction, and rotate the at least one second roller thereby causing the second conveyor belt to rotate in a second direction opposite the first direction.

In another embodiment of the first aspect, the at least one control unit is further configured to rotate the at least one first roller at a first linear speed and rotate the at least one second roller at a second linear speed.

In another embodiment of the first aspect, the second linear speed is the same as the first linear speed.

In another embodiment of the first aspect, the second linear speed is higher than the first linear speed.

In another embodiment of the first aspect, the at least one control unit controls a motor that is coupled to one of the main cleaning component or the guiding component, and the motor rotates the at least one first roller and the at least one second roller.

In another embodiment of the first aspect, the at least one control unit controls a first motor that is coupled to the main cleaning component. The at least one control unit further controls a second motor that is coupled to the guiding component. The first motor rotates the at least one first roller, and the second motor rotates the at least one second roller.

In another embodiment of the first aspect, the first motor is coupled to the at least one first roller through a first transmission belt to cause the at least one first roller to rotate, and the second motor is coupled to the at least one second roller through a second transmission belt to cause the at least one second roller to rotate.

In another embodiment of the first aspect, each of the at least one first and one second plane forming members includes one of a roller body, a rod body having an at least partially cylindrical outer surface, or a non-circular body having an at least partially arc-like outer surface.

In another embodiment of the first aspect, the first and second conveyor belts move the object to the container by removing the object from the surface and moving the object through a space created between a back side of the second conveyor belt and a front side of the first conveyor belt.

In another embodiment of the first aspect, the second conveyor belt is movably coupled to the first conveyor belt through one or more connecting frames, and as the object moves through the space, the second conveyor belt automatically adjusts the space.

In another embodiment of the first aspect, a size of the space changes as the object moves through the space and toward the container.

In another embodiment of the first aspect, the size of the space is changed based on a change in at least one of a width of the space, a length of the space, or a height of the space.

In another embodiment of the first aspect, a surface of the first conveyor belt is made of a first material, and a surface of the second conveyor belt is made of a second material.

In another embodiment of the first aspect, the first and second materials are the same.

In another embodiment of the first aspect, a rigidity of the first material is less than a rigidity of the second material.

In another embodiment of the first aspect, the main cleaning component and the guiding component remove the object from the surface and move the object to the container without using an air blowing power or an air suction power.

In another embodiment of the first aspect, the first and second conveyor belts are at least partially parallel and positioned at an angel relative to the surface.

In another embodiment of the first aspect, the cleaning device further includes an airflow unit configured to further facilitate removing the object from the surface and moving the object to the container by pulling the object through a space between the main cleaning component and the guiding component.

In another embodiment of the first aspect, the first conveyor belt has a top side and a bottom side, and the bottom side of the first conveyor belt forms a first plane that presses against the surface.

In another embodiment of the first aspect, a surface area of the first plane is greater than a surface area of the top side of the first conveyor belt.

In another embodiment of the first aspect, the first plane presses against the surface partially due to a weight of the main cleaning component and partially due to a weight shifting of the guiding component onto the main cleaning component.

In another embodiment of the first aspect, the second conveyor belt has a bottom side including a second plane, and an area of the first plane is greater than an area of the second plane.

In another embodiment of the first aspect, the second plane also presses against the surface.

In another embodiment of the first aspect, the first plane presses against the surface such that the first plane is entirely in contact with the surface, and the second plane presses against the surface such that the second plane is partially in contact with the surface.

In another embodiment of the first aspect, the second conveyor belt is configured to direct the object on the surface toward the first conveyor belts and, while acting in concert with the first conveyor belt, toward the container.

In another embodiment of the first aspect, a bottom side of the second conveyor belt forms an induction slope near the surface. The induction slope extends in a direction away from the first conveyor belt and from the surface, and the induction slop of the second conveyor belt causes objects having different sizes to be driven toward the first conveyor belt.

In another embodiment of the first aspect, the second conveyor belt is longer than the first conveyor belt and rotates in the opposite direction of the first conveyor belt.

In another embodiment of the first aspect, the cleaning device further includes a drying component that is positioned behind the main cleaning component along a moving direction of the cleaning device, the drying component configured to dry at least one of the surface and the main cleaning component.

In another embodiment of the first aspect, the drying component includes at least a scraper and a drive unit for moving the scraper.

In another embodiment of the first aspect, the drive unit moves the scraper down to scrape the surface when the surface includes a first type of surface and moves the scraper up to retract the scraper from contacting the surface when the surface includes a second type of surface.

In another embodiment of the first aspect, the first type of surface includes a smooth surface and/or a flat surface and the second type of surface includes a rough surface and/or an uneven surface.

In another embodiment of the first aspect, the drying component further includes an airflow unit configured to blow air toward a first space between the main cleaning component and the scraper and a second space behind the scraper along a moving direction of the cleaning device.

In another embodiment of the first aspect, the airflow unit includes an electric heating member configured to generate heat, and the electric heating member includes at least one of a resistance wire and a ceramic.

In another embodiment of the first aspect, the airflow unit includes an infrared heating member, and the infrared heating member is configured to warm at least one of a bottom portion of the first conveyor belt and the surface.

In another embodiment of the first aspect, the cleaning device further includes a liquid outlet component configured to direct liquid toward at least one of a bottom portion of the first conveyor belt, a bottom portion of the second conveyor belt, and the surface.

In another embodiment of the first aspect, the cleaning device further includes a first drying component and a second drying component, wherein the first drying component is positioned behind the first conveyor belt along the moving direction of the cleaning device and the second drying component is positioned in front of the second conveyor belt along the moving direction of the cleaning device.

In another embodiment of the first aspect, when the cleaning device moves forward, the first drying component is used for removing liquid from the surface, and when the cleaning device moves backward, the second drying component is used for removing the liquid from the surface.

In another embodiment of the first aspect, the first drying component includes a first scraper and a first motor for moving the first scraper, the second drying component includes a second scraper and a second motor for moving the second scraper, when the cleaning device moves forward, the first motor moves the first scraper such that to press against the surface and the second motor moves the second scraper such that to be separated from the surface, and when the cleaning device moves backward, the second motor moves the second scraper such that to press against the surface and the first motor moves the first scraper such that to be separated from the surface.

In another embodiment of the first aspect, the first drying component further includes a first airflow unit for blowing air toward a space between the first conveyor belt and the first scraper, and the second drying component further includes a second airflow unit for blowing the air toward a space between the second conveyor belt and the second scraper.

In another embodiment of the first aspect, the cleaning device further includes a baffle component that is used for guiding objects toward the container.

In another embodiment of the first aspect, the baffle component includes a first bezel for scraping the first objects off the first conveyor belt and guiding the first objects toward the container.

In another embodiment of the first aspect, the container is positioned behind the main cleaning component along the moving direction of the cleaning device, and the first bezel is positioned behind the first conveyor belt and extending from a back side of the first conveyor belt toward the container.

In another embodiment of the first aspect, the baffle component further includes a second bezel positioned beneath the first bezel. The container includes a first chamber and a second chamber beneath the first chamber. The first bezel is associated with the first chamber and the second bezel is associated with the second chamber. The first bezel is configured to guide a first type of the first objects carried on the first conveyor belt to the first chamber, and the second bezel is configured to guide a second type of the first objects carried on the first conveyor belt to the second chamber.

In another embodiment of the first aspect, the second type of the first objects are smaller than the first type of the first objects.

In another embodiment of the first aspect, the baffle component further includes a third bezel for scraping second objects off the second conveyor belt and guiding the second objects toward at least one of the main cleaning component and the container.

In another embodiment of the first aspect, the third bezel is positioned (i) behind the second conveyor belt along the direction of travel of the cleaning device and (ii) near a top portion of the second conveyor belt.

In another embodiment of the first aspect, the cleaning device further includes a main frame and a connecting frame that connects the guiding component to the main cleaning component. The connecting frame is slidably coupled to the main frame in a liftable manner.

In another embodiment of the first aspect, the cleaning device further includes a driving component disposed at a bottom portion of the main frame. The driving component includes a plurality of wheels.

In another embodiment of the first aspect, the cleaning device further includes a control unit configured to control and drive the main frame using at least the driving component.

In another embodiment of the first aspect, the connecting frame is slidably coupled to the main frame through a combination of a guide rail and a sliding member and/or a combination of a gear and a rack.

In another embodiment of the first aspect, the cleaning device further includes an elevating component configured to move at least the main cleaning component up and down to create and remove, respectively, a space between the main cleaning component and the surface.

In another embodiment of the first aspect, the elevating component includes at least an auxiliary support member positioned at a bottom of a main frame of the cleaning device in a retractable manner.

In another embodiment of the first aspect, the elevating component further includes a driving component that is coupled to the auxiliary support member and that causes the auxiliary support member to retract and release.

In another embodiment of the first aspect, the auxiliary support member includes at least one roller or a wheel.

In another embodiment of the first aspect, the cleaning device is configured to have a first mode and a second mode. in the first mode, the auxiliary support member is in a retracted state such that the auxiliary support member is separated from the surface while the main cleaning component is pressed against the surface, and in the second mode, the auxiliary support member is in a released state such that the auxiliary support member is in contact with the surface while the main cleaning component is separated from the surface.

In another embodiment of the first aspect, in the first mode, the guiding component is also pressed against the surface, and in the second mode, the guiding component is also separated from the surface.

In a second aspect of the present disclosure, a cleaning device for cleaning a surface is provided. The cleaning device includes a first conveyor belt configured to clean the surface and a second conveyor belt positioned in front of the first conveyor belt along a moving direction of the cleaning device such that the first and second conveyor belts are at least partially parallel to each other. the second conveyor belt is configured to, along the first conveyor belt, remove objects from the surface as the cleaning device moves over the object, and the first or second conveyor belts are arranged at a tilted angle relative to the surface to facilitate moving the object from the surface toward a container.

In another embodiment of the second aspect, a front side of the first conveyor belt faces a back side of the second conveyor belt along a moving direction of the cleaning device, and the second conveyor belt, acting along the first conveyor belt, to remove the objects from the surface includes the first and second conveyor belts rotating in opposite directions to remove the objects from the surface and to move the objects through an adjustable space created between the first and second conveyor belts toward the container.

In another embodiment of the second aspect, the cleaning device further includes at least one of a handheld unit or an engine unit for moving the cleaning device in different directions.

In another embodiment of the second aspect, the first conveyor belt rotatably surrounds a first roller and at least one first plane forming member. The first roller and the at least one first plane forming member are spaced apart from each other along a height of the cleaning device. The second conveyor belt rotatably surrounds a second roller and at least one second plane forming member, and the second roller and the at least one second plane forming member are spaced apart from each other along a height of the cleaning device.

In another embodiment of the second aspect, the cleaning device further includes a control unit configured to rotate the first roller thereby causing the first conveyor belt to rotate in a first direction, and rotate the second roller thereby causing the second conveyor belt to rotate in a second direction opposite the first direction.

In another embodiment of the second aspect, the control unit is further configured to rotate the first roller at a first linear speed and rotate the second roller at a second linear speed.

In an embodiment of the second aspect, the second linear speed is the same as, or higher than, the first linear speed.

In another embodiment of the second aspect, the control unit controls a motor that is mounted on the cleaning device, and the motor rotates the first roller and the second roller.

In another embodiment of the second aspect, the control unit controls a first motor and a second motor. The first motor rotates the first roller and the second motor rotates the second roller.

In another embodiment of the second aspect, the first motor is coupled to the first roller through a first transmission belt to cause the first roller to rotate, and the second motor is coupled to the second roller through a second transmission belt to cause the second roller to rotate.

In another embodiment of the second aspect, the at least one first plane forming member includes two plane forming members for causing a bottom portion of the first conveyor belt near the surface to form a plane that presses against the surface, and the at least one first roller is positioned above the two plane forming members along the height of the cleaning device.

In another embodiment of the second aspect, the two plane forming members and the first roller are positioned such that to form the first conveyor belt as a triangular shape.

In another embodiment of the second aspect, the first and second conveyor belts move the object to the container by removing the object from the surface and moving the object upward through a space created between a back side of the second conveyor belt and a front side of the first conveyor belt.

In another embodiment of the second aspect, a size of the space changes as the object moves through the space and toward the container.

In another embodiment of the second aspect, the size of the space is changed based on a change in at least one of a width of the space, a length of the space, and a height of the space.

In another embodiment of the second aspect, a surface of the first conveyor belt is made of a first material and a surface of the second conveyor belt is made of a second material.

In another embodiment of the second aspect, a rigidity of the first material is less than a rigidity of the second material.

In another embodiment of the second aspect, the first and second conveyor belts remove the object from the surface and move the object toward the container without using an air blowing power or an air suction power.

In another embodiment of the second aspect, the cleaning device further includes an air suction/blowing component configured to further facilitate removing the object from the surface and moving the object toward the container by means of pulling the object through a space between the first and second conveyor belts.

In another embodiment of the second aspect, a bottom side of the second conveyor belt forms an induction slope near the surface. The induction slope extends in a direction away from the first conveyor belt and the surface and the induction slop of the second conveyor belt causes objects having different sizes to be driven toward the first conveyor belt and thereafter to the container.

In another embodiment of the second aspect, the second conveyor belt is longer than the first conveyor belt and rotates as fast as, and in the opposite direction of, the first conveyor belt.

In another embodiment of the second aspect, the second conveyor belt is movably attached to the first conveyor belt such that when picking up the objects from the surface, the second conveyor belt automatically adjusts a space between the first and second conveyor belt.

In a third aspect of the present disclosure, a method for controlling the cleaning device according to any of the above mentioned aspects is provided. The method includes receiving an instruction from a user to start cleaning a surface, switching the cleaning device from the second mode to the first mode, and causing the cleaning device to move on the surface such that as the cleaning device moves over the objects on the surface, the cleaning device cleans the surface from the object. In the first mode, the control unit causes the first and second rotational conveyor belts to rotate in opposite directions, the liquid outlet component directs cleaning liquid toward the main cleaning component, the airflow units of the drying component blow the air toward the surface and the middle of the scraper, and the scraper scrapes the surface behind the main cleaning component.

In a fourth aspect of the present disclosure, a method for controlling the cleaning device according to any of the above mentioned aspects is provided. The method includes receiving an instruction from a user to clean the surface, and instructing a control unit of the cleaning device to clean the surface such that the cleaning device moves on the surface and over the objects to clean the surface from the objects.

In another embodiment of the fourth aspect, the method further includes instructing the control unit to rotate the first roller and the second roller to cause the first and second conveyor belts to rotate in the opposite directions and clean the surface.

In another embodiment of the fourth aspect, the cleaning device moves on the surface using the plurality of wheels positioned at the bottom portion of the cleaning device.

In another embodiment of the fourth aspect, the method further includes causing the elevating component to move the scraper down to press against the surface.

In another embodiment of the fourth aspect, the method further includes causing the airflow unit of the drying component to blow the air toward the surface such that to dry the surface in front of and/or behind the scraper along the moving direction of the cleaning device.

In another embodiment of the fourth aspect, the method further includes controlling the liquid outlet component to direct the cleaning liquid toward the surface at least one of in front of the main cleaning component and behind the main cleaning component to clean the surface.

In another embodiment of the fourth aspect, the method further includes receiving a first instruction to switch a mode of the cleaning device to a first mode, and while in the first mode causing the cleaning device to move on the surface and over the objects, and causing the first and second conveyor belts to rotate in opposite directions to remove the objects from the surface and guide the removed objects toward the container of the cleaning device.

In another embodiment of the fourth aspect, the method further includes causing the liquid outlet component to direct the liquid toward the surface.

In another embodiment of the fourth aspect, the method further includes causing the drying component to dry the surface.

In another embodiment of the fourth aspect, the drying component dries the surface by at least one of causing the at least one airflow unit to blow the air toward the surface to guide the liquid to the center of the scraper, or causing the scraper to scrape the surface behind the main cleaning component to remove the liquid from the surface and dry the surface after the objects are removed from the surface.

In another embodiment of the fourth aspect, the method further includes receiving a second instruction to switch the mode of the cleaning device to a second mode, instructing the control unit to cause the cleaning device to switch to the second mode, and while in the second mode, causing the elevating component to release the auxiliary support member.

In another embodiment of the fourth aspect, when the auxiliary support member is released, both the main cleaning component and the guiding component are separated from the surface and a space is created between the cleaning device and the surface.

In another embodiment of the fourth aspect, the method further includes while in the second mode, causing the first conveyor belt and the second conveyor belt to stop rotating.

In another embodiment of the fourth aspect, the method further includes while in the second mode, causing the drying component to stop drying the surface.

In another embodiment of the fourth aspect, the drying component stops drying the surface by at least one of disengaging the scraper from scraping the surface, or turning off the airflow units to stop them from blowing the air toward the surface.

In another embodiment of the fourth aspect, the method further includes receiving an instruction to switch a mode of the cleaning device to a self-cleaning mode, and activating the self-cleaning mode by causing the scraper to move toward the main cleaning component such that the scraper scrapes against the first conveyor belt of the main cleaning component.

In a fifth aspect of the present disclosure, a cleaning device is provided. The cleaning device includes at least one processor and one or more computer-readable media coupled to the at least one processor. The one or more computer-readable media storing a computer program that, when executed by the at least one processor, performs the method according to any one of the above aspects.

In a sixth aspect of the present disclosure, a cleaning device for cleaning a surface is provided. The cleaning device includes a container, a main cleaning component including a conveyor belt, and a guiding component positioned in front of the main cleaning component along a moving direction of the cleaning device. A back side of the guiding component is adjacent a front side of the conveyor belt. The guiding component guides an object on the surface toward the main cleaning component, and the guiding component and a rotating conveyor belt move the object toward the container.

In an embodiment of the sixth aspect, the back side of the guiding component includes a plate. When the cleaning device is in a self-cleaning mode, the plate scrubs against the rotating conveyor belt to clean the conveyor belt.

In another embodiment of the sixth aspect, the plate has a surface includes a plurality of convex portions and a plurality of convex portions, and the pluralities of convex and concave portions of the plate scrub against the rotating conveyor belt to clean the conveyor belt.

In another embodiment of the sixth aspect, the plate has a wedge-shaped protrusion that scrubs against the rotating conveyor belt to clean the conveyor belt.

In another embodiment of the sixth aspect, the plate includes a flexible serrated surface that scrubs against the rotating conveyor belt to clean the conveyor belt.

In another embodiment of the sixth aspect, the conveyor belt is a first conveyor belt, and the guiding component includes a second conveyor belt.

In another embodiment of the sixth aspect, the cleaning device further includes a control unit and at least one motor. The control unit controls the at least one motor to rotate the first conveyor belt in a first direction, and the control unit controls the at least one motor to rotate the second conveyor belt in a second direction.

In another embodiment of the sixth aspect, when the cleaning device is in a cleaning mode, the first and second directions are opposite directions, and when the cleaning device is in a self-cleaning mode, the first and second directions are a same direction.

In another embodiment of the sixth aspect, when the cleaning device is in the cleaning mode, a back side of the second conveyor belt and the front side of the first conveyor belt move the object upward through a space created between the first and second conveyor belts toward the container.

In another embodiment of the sixth aspect, when the cleaning device is in the self-cleaning mode, a backside of the second conveyor belt rubs against the front side of the first conveyor belt to clean the first conveyor belt.

In another embodiment of the sixth aspect, a linear speed of rotation of the first conveyor belt is different than a linear speed of rotation of the second conveyor belt.

In another embodiment of the sixth aspect, the cleaning device further includes a liquid outlet component. When the cleaning device is in a self-cleaning mode, the control unit further controls the liquid outlet component to direct a cleaning liquid to at least one of the first conveyor belt or the second conveyor belt.

In another embodiment of the sixth aspect, the cleaning device further includes a scraper that is positioned behind the main cleaning component along a moving direction of the cleaning device. When the cleaning device is in a self-cleaning mode, the scraper is configured to move forward to scrape against the conveyor belt to clean the conveyor belt.

In another embodiment of the sixth aspect, the cleaning device further includes a baffle component including at least one bezel configured to scrape the object off the conveyor belt and guide the object toward the container.

In another embodiment of the sixth aspect, the container is positioned behind the main cleaning component along the moving direction of the cleaning device, and the at least one bezel is positioned behind the conveyor belt and extends from a back side of the conveyor belt toward the container.

In another embodiment of the sixth aspect, the container includes a first chamber and a second chamber beneath the first chamber. The at least one bezel includes a first bezel and a second bezel beneath the first bezel. The first bezel is associated with the first chamber and the second bezel is associated with the second chamber. The first bezel is configured to guide a first type of objects carried on the conveyor belt to the first chamber. The second bezel is configured to guide a second type of objects carried on the conveyor belt to the second chamber.

In another embodiment of the sixth aspect, the second type of objects are smaller than the first type of objects.

In another embodiment of the sixth aspect, the conveyor belt is a first conveyor belt, the guiding component includes a second rotatable conveyor belt, and the baffle component further includes a third bezel that is configured to scrape objects off the second conveyor belt and guiding the objects toward at least one of the main cleaning component and the container.

In another embodiment of the sixth aspect, the third bezel is positioned behind the second conveyor belt along the moving direction of the cleaning device and near a top portion of the second conveyor belt.

In a seventh aspect of the present disclosure, a cleaning device is provided. The cleaning device has a first mode of operation for cleaning a surface and a second mode of operation for self-cleaning. The cleaning device includes a main cleaning component including a conveyor belt, and a drying component including at least a scraper positioned behind the conveyor belt along a moving direction of the cleaning device. When the cleaning device is in the first mode of operation, the scraper is configured to move down to scrape against the surface. When the cleaning device is in the second mode of operation, the scraper is configured to move forward to scrape against the conveyor belt.

In an embodiment of the seventh aspect, the cleaning device further includes a third mode of operation. The scraper is configured to move up and away from the surface when the cleaning device is in the third mode of operation.

In another embodiment of the seventh aspect, the cleaning device further includes a control unit configured to move the scraper in different directions as a mode of operation of the cleaning device changes between the first, second, and third modes of operation.

In another embodiment of the seventh aspect, the cleaning device operates in the second and third modes of operation simultaneously.

In another embodiment of the seventh aspect, the cleaning device is in the third mode of operation when the cleaning device is off or when the cleaning device determines that a type of surface does not allow the cleaning device to operate in the first mode of operation.

In another embodiment of the seventh aspect, the cleaning device is in the first mode of operation and cleans the surface when the surface includes a first type of surface, and the cleaning device is in the third mode of operation when the surface includes a second type of surface that does not allow the cleaning device to be in the first mode of operation.

In another embodiment of the seventh aspect, the first type of surface includes a flat and smooth surface while the second type of surface includes an uneven and rough surface.

In another embodiment of the seventh aspect, the cleaning device automatically switches from the first mode to the third mode when the cleaning device determines that a type of the surface has changed.

In another embodiment of the seventh aspect, the cleaning device further includes a container. A bottom portion of the conveyor belt presses against the surface while the conveyor belt is rotating in a first direction to remove an object from the surface and carry the object toward the container.

In another embodiment of the seventh aspect, in the first mode of operation, the scraper scrapes against the surface to remove liquid from the surface after the main cleaning component has moved over the surface.

In another embodiment of the seventh aspect, the cleaning device further includes a liquid outlet component configured to direct liquid toward at least one of the main cleaning component and the surface.

In another embodiment of the seventh aspect, the liquid includes at least one of water, a disinfectant, or a sanitizer.

In another embodiment of the seventh aspect, the cleaning device further includes a main frame. The drying component further includes at least one elastic member that couples the scraper to the main frame and is configured to provide a tensile force to the scraper.

In another embodiment of the seventh aspect, the drying component further includes a mounting base that is mounted on the main frame and the scraper is moveably coupled to the mounting base.

In another embodiment of the seventh aspect, a direction of the tensile force provided by the at least one elastic member is arranged at an angle with respect to a rising direction of the scraper.

In another embodiment of the seventh aspect, the at least one elastic member includes one or more springs.

In another embodiment of the seventh aspect, a driving unit of the drying component includes a lifting mechanism configured to adjust a distance between the scraper and the surface, and a rotating mechanism configured to rotate the scraper.

In another embodiment of the seventh aspect, the drying component further includes at least one airflow unit positioned near at least one end side of the scraper. The at least one airflow unit blows air toward the surface when the cleaning device is in the first operation mode, and the at least one airflow unit blows air toward the conveyor belt when the cleaning device is in the second operation mode.

In another embodiment of the seventh aspect, the at least one airflow unit includes first and second airflow units, and the first and second airflow units are positioned near two end sides of the scraper.

In another embodiment of the seventh aspect, the first and second airflow units are positioned near the two end sides of the scraper and between the main cleaning component and the scraper.

In another embodiment of the seventh aspect, the scraper includes a fixed portion made of hard material and a flexible portion made of soft material. The fixed portion is mounted at a bottom portion of the cleaning device. The flexible portion contacts the surface.

In another embodiment of the seventh aspect, the fixed portion includes a first fixture and a second fixture configured to clamp the moving member between them.

In another embodiment of the seventh aspect, the scraper includes a plurality of elongated layers, and heights of at least two different elongated layers of the scraper are different.

In another embodiment of the seventh aspect, a first height of a first layer of the scraper at a front side of the scraper along the moving direction of the cleaning device is less than a second height of a second layer of the scraper at a back side of the scraper.

In an eighth aspect of the present disclosure, a cleaning device for cleaning a surface is provided. The cleaning device includes a container configured to store objects, a main cleaning component including a conveyor belt that is configured to remove the objects from the surface and move the objects toward the container, and a baffle component configured to guide the objects moved by the conveyor belt to the container.

In an embodiment of the eighth aspect, the conveyor belt carries the objects toward the container and the baffle component guides the objects from the conveyor belt to the container without using an air blowing/suction power.

In another embodiment of the eighth aspect, the conveyor belt rotates in a clockwise direction while the cleaning device moves forward such that to remove the objects from the surface and to carry the objects toward the container.

In another embodiment of the eighth aspect, the baffle component includes at least a first bezel. At least part of the container is positioned behind the conveyor belt along a moving direction of the cleaning device, and the first bezel is positioned behind the conveyor belt and extends from a back side of the conveyor belt toward the at least part of the container.

In another embodiment of the eighth aspect, the first bezel is configured to scrape the objects off the conveyor belt and guide the objects toward the at least part of the container.

In another embodiment of the eighth aspect, the conveyor belt is a first conveyor belt. The cleaning device further includes a guiding component configured to guide the objects toward the main cleaning component as the cleaning device moves forward. The guiding component includes a second conveyor belt, and the second conveyor belt rotates in a counterclockwise direction, such that, acting in concert with the first conveyor belt, to remove the objects from the surface and to move the objects toward the container.

In another embodiment of the eighth aspect, the baffle component includes first and second bezels configured to scrape the objects off the first and second conveyor belts, respectively, and guide the objects toward the container.

In another embodiment of the eighth aspect, the first bezel is positioned behind the first conveyor belt along a moving direction of the cleaning device and extends from a back side of the first conveyor belt toward the container, and the second bezel is positioned in front of the main cleaning component and behind the second conveyor belt and near a top portion of the second conveyor belt.

In another embodiment of the eighth aspect, the container includes a first chamber and a second chamber. The baffle component further includes a second bezel that is positioned behind the main cleaning component along a moving direction of the cleaning device, and below the first bezel along a height of the cleaning device. The first bezel is configured to scrape a first type of objects off the conveyor belt and guide the first type of objects toward the first chamber, and the second bezel is configured to scrape a second type of objects off the conveyor belt and guide the second type of objects toward the second chamber.

In another embodiment of the eighth aspect, the second type of objects are smaller than the first type of objects.

In another embodiment of the eighth aspect, the first type of objects includes solid garbage and the second type of objects includes liquid waste.

In another embodiment of the eighth aspect, the first bezel is positioned near a top portion of the conveyor belt.

In another embodiment of the eighth aspect, a space between the first bezel and the back side of the conveyor belt is greater than a space between the second bezel and the back side of the conveyor belt.

In another embodiment of the eighth aspect, the container is a first container and the conveyor belt is a first conveyor belt. The cleaning device further includes a second container, and a guiding component configured to guide the objects toward the main cleaning component as the cleaning device moves forward. The guiding component includes a second conveyor belt. The guiding component is positioned in front of the main cleaning component in a moving direction of the cleaning device. The first container is positioned behind the first conveyor belt along the moving direction of the cleaning device. The second container is positioned in front of the second conveyor belt along the moving direction of the cleaning device. The baffle component includes first and second bezels. The first bezel is positioned behind the first conveyor belt and extends from a back side of the first conveyor belt toward the first container. The first bezel is configured to scrape first one or more objects off the first conveyor belt as the first conveyor belt rotates in a clockwise direction and to guide the first one or more objects toward the first container. The second bezel is positioned in front of the second conveyor belt and extends from a front side of the second conveyor belt toward the second container. The second bezel is configured to scrape second one or more objects off the second conveyor belt as the second conveyor belt rotates in a counterclockwise direction and to guide the second one or more objects toward the second container.

In another embodiment of the eighth aspect, the baffle component further includes a third bezel. The third bezel is positioned in front of the second conveyor belt and below the second bezel along a height of the cleaning device. The second bezel is configured to scrape a first type of objects from the second one or more objects off the second conveyor belt and guide the first type of objects toward the first chamber. The third bezel is configured to scrape a second type of objects of the second one or more objects off the second conveyor belt and guide the second type of objects toward the second chamber.

In another embodiment of the eighth aspect, the second type of objects are smaller than the first type of objects.

In another embodiment of the eighth aspect, the first type of objects includes solid garbage and the second type of objects includes liquid garbage.

In another embodiment of the eighth aspect, the second bezel is positioned near a top portion of the second conveyor belt.

In another embodiment of the eighth aspect, a space between the second bezel and the front side of the second conveyor belt is greater than a space between the third bezel and the front side of the second conveyor belt.

In another embodiment of the eighth aspect, the cleaning device further includes a liquid outlet component configured to output cleaning liquid toward at least one of the main cleaning component and the surface.

In another embodiment of the eighth aspect, the baffle component includes at least first and second bezels. The container includes first and second chambers. The first bezel is positioned behind the conveyor belt along a moving direction of the cleaning device and extends from a back side of the conveyor belt toward the first chamber. The second bezel is positioned behind the conveyor belt and below the first bezel along a height of the cleaning device and extends from the back side of the conveyor belt toward the second chamber. The liquid outlet component is positioned behind the conveyor belt and below the first and second bezels such that to output the cleaning liquid toward at least one of the main cleaning component and the surface.

In another embodiment of the eighth aspect, the liquid outlet component includes a bar having a plurality of holes configured to output the cleaning liquid toward at least one of the main cleaning component and the surface.

With one or more of the above aspects of the present disclosure, cleaning effect and efficiency of the cleaning device with respect to a surface to be cleaned is improved.

### BRIEF DESCRIPTION OF THE DRAWINGS

Aspects of the exemplary disclosure are best understood from the following detailed description when read with the accompanying figures. Various features are not drawn to scale, and dimensions of various features may be arbitrarily increased or reduced for clarity of discussion.

FIG. 1A is a diagram illustrating a cleaning device, in accordance with an example embodiment of the present disclosure.

FIG. 1B is a diagram illustrating an exposed cleaning device, in accordance with an example embodiment of the present disclosure.

FIG. 2 is a diagram illustrating a main cleaning component and a guiding component of the cleaning device, in accordance with an example embodiment of the present disclosure.

FIG. 3 is diagram illustrating an example of a roller of the main cleaning component, in accordance with an example embodiment of the present disclosure.

FIGS. 4A-4G are seven diagrams illustrating example shapes of the main cleaning component generated by one or more rollers and plane forming members, in accordance with another example embodiment of the present disclosure.

FIG. 4H is a diagram illustrating another example shape of the main cleaning component generated by one or more rollers, plane forming members, and/or other components, in accordance with an example embodiment of the present disclosure.

FIGS. 5A and 5B are two diagrams illustrating example embodiments of a guiding component of the cleaning device, in accordance with an example embodiment of the present disclosure.

FIGS. 5C and 5D are two diagrams illustrating other example embodiments of a guiding component of the cleaning device, in accordance with an example embodiment of the present disclosure.

FIG. 6A-6C are three diagrams illustrating other utilizations of the guiding component, in accordance with an example embodiment of the present disclosure.

FIGS. 7A and 7B are two diagrams illustrating example embodiments of an external force for moving the cleaning device, in accordance with an example embodiment of the present disclosure.

FIG. 8 is a diagram illustrating an external force for rotating the conveyor belt(s) of the cleaning device, in accordance with an example embodiment of the present disclosure.

FIGS. 9A and 9B are two diagrams illustrating example embodiments of a drying component of the cleaning device, in accordance with an example embodiment of the present disclosure.

FIG. 9C is a diagram illustrating different modes of a scraper of the cleaning device, in accordance with an example embodiment of the present disclosure.

FIG. 10 is a diagram illustrating other components, such as different configurations of a container, a baffle component, and a liquid outlet component, of the cleaning device, in accordance with an example embodiment of the present disclosure.

FIGS. 11A and 11B are two diagrams illustrating example embodiments of a driving component of the cleaning device, in accordance with an example embodiment of the present disclosure.

FIGS. 12A and 12B are two diagrams illustrating example embodiments of an elevating component of the cleaning device, in accordance with an example embodiment of the present disclosure.

FIG. 13 is a block diagram illustrating an electronic system of the cleaning device, according to one example embodiment of the present disclosure.

### DETAILED DESCRIPTION OF THE INVENTION

The following description contains specific information pertaining to example embodiments in the present disclosure. The drawings in the present disclosure and their accompanying detailed description are directed to merely these example embodiments. However, the present disclosure is not limited to merely these example embodiments. Other variations and example embodiments will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purpose of consistency and case of understanding, like features may be identified (although, in some example embodiments, not shown) by the same numerals in the example figures. However, the features in different example embodiments may be differed in other respects, and thus shall not be narrowly confined to what is shown in the figures.

The description uses the phrases “in some embodiments,” or “in some implementations,” which may each refer to one or more of the same or different embodiments. The term “coupled” is defined as connected, whether directly or indirectly through intervening components, and is not necessarily limited to physical connections. The term “comprising,” when utilized, means “including, but not necessarily limited to”, which specifically indicates open-ended inclusion or membership in the so-described combination, group, series and the equivalent. The expression “at least one of A, B and C” or “at least one of the following: A, B and C” means “only A, or only B, or only C, or any combination of A, B and C.”

According to any sentence, paragraph, (sub)-bullet, point, action, behavior, term, alternative, aspect, example, implementation, or claim described in the present disclosure, “X/Y” may include the meaning of “X or Y”. According to any sentence, paragraph, (sub)-bullet, point, action, behavior, term, alternative, aspect, example, implementation, or claim described in the present disclosure, “X/Y” may also include the meaning of “X and Y”. According to any sentence, paragraph, (sub)-bullet, point, action, behavior, term, alternative, aspect, example, implementation, or claim described in the present disclosure, “X/Y” may also include the meaning of “X and/or Y”.

Any sentence, paragraph, (sub)-bullet, point, action, behavior, term, alternative, aspect, example, or claim described in the present disclosure may be combined logically, reasonably, and properly to form a specific method. Any sentence, paragraph, (sub)-bullet, point, action, behavior, term, alternative, aspect, example, or claim described in the present disclosure may be implemented independently and separately to form a specific method. Dependency, (e.g., “based on”, “more specifically”, “in some embodiments”, “in one alternative”, “in one example”, “in one aspect”, or etc.), in the present disclosure is just one possible example in which would not restrict the specific method.

It should be noted that all the directional indications (e.g., up, down, left, right, front, back, etc.) in the embodiments are only used to explain a relative position relationship, motion condition or the like among components in a specific stance, and if the specific stance changes, the directional indications may also change accordingly.

It should also be noted that when a component is described as “fixed to” or “disposed on/disposed at” another component, the component may be directly on the another component, or a mediate component may also exist. When a component is described as “connected” to another component, the component may be directly connected to the another component or indirectly connected to the another component via a mediate component.

In addition, the descriptions associated with “first”, “second”, etc., in the present disclosure are only used for descriptive purposes, and shall not be understood as indication or implication of relative importance or implicit indication of the number of indicated technical features. Therefore, the features defined by “first” and “second” may explicitly or implicitly include at least one of these features. In addition, the technical solutions among various embodiments may be combined with each other, and the combination of the technical solutions may be based on the ability of those of ordinary skill in the art to achieve. When the combination is contradictory or fails to be achieved, it should be considered that such a combination of the technical solutions does not exist and is not within the protection scope of the present disclosure.

As discussed above, the present disclosure is directed to a cleaning device for cleaning a surface, a control method, a controller, and a computer readable storage medium of the cleaning device. The cleaning device described in the present disclosure may perform multiple cleaning actions at once. For example, the cleaning device of some of the present disclosure may provide three different types of cleaning, which may include sweeping, moping, and drying, in a single module. The cleaning device may be installed on and/or used with separate (and manually-applied) cleaning equipment (e.g., may be installed on a sweeping-cleaning apparatus, such as a broomstick, a moping-cleaning apparatus, such as a mop, a vacuum-cleaning apparatus, such as a handheld vacuum, etc.). The cleaning device of the present disclosure may be further equipped with sensors, such as positioning sensors/modules, transceivers, and circuitry to provide automated cleaning (e.g., as in a mobile robotic cleaner, robot vacuum, etc.).

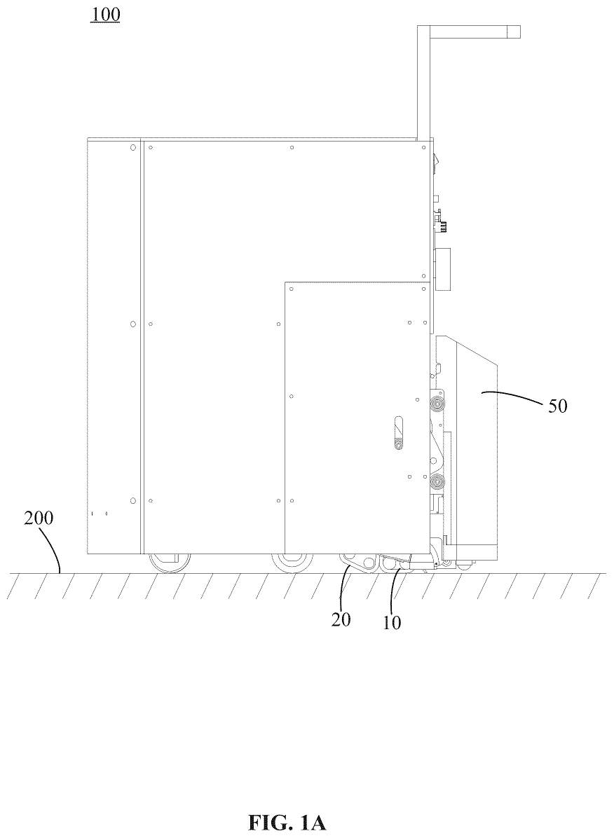

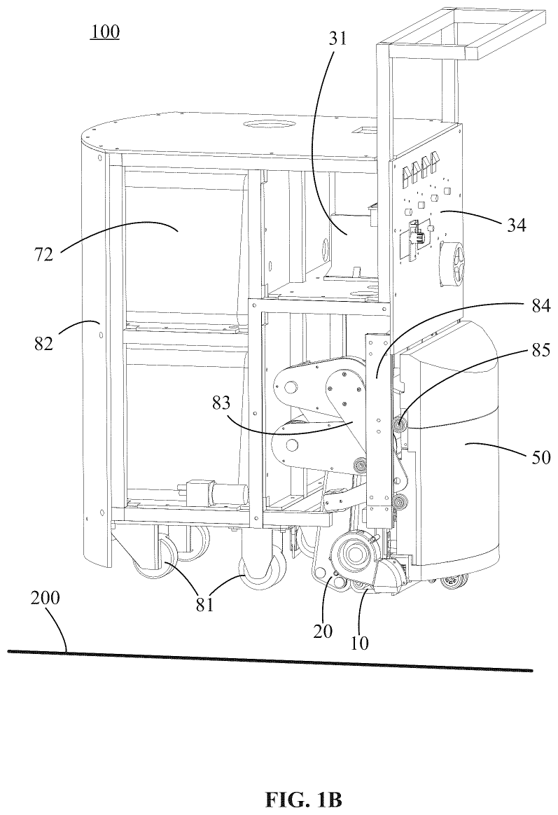

FIG. 1A is a diagram illustrating a cleaning device, in accordance with an example embodiment of the present disclosure. In some embodiments, a cleaning device 100 may clean a surface 200 and/or remove objects (e.g., garbage, trash, waste, etc.) from the surface 200. The surface 200 may include floor, a ground, a wall, a window, a ceiling, a glass surface or other surfaces in a residential building, a commercial building, a factory, etc. The cleaning device 100 may include, among other components, a main cleaning component 10, a guiding component 20, and a container 50. The guiding component 20, in some embodiments, may direct an object (e.g., garbage) on the surface 200 towards the main cleaning component 10, and in conjunction with the main cleaning component 10, may transfer the object to the container 50. The main cleaning component 10 and the guiding component 20 may direct the object to the container 50 through a space created between the guiding component 20 and the main cleaning component 10.

FIG. 1B is a diagram illustrating an exposed cleaning device, in accordance with an example embodiment of the present disclosure. As shown in FIG. 1B, the main cleaning component 10 and the guiding component 20 of the cleaning device 100 are moveably connected to each other through one or more connecting members, such as a main frame 82, a connecting frame 83, a guide rail 84, and a sliding member 85. FIG. 1B also shows the main frame 82 including a control unit 31, a user interaction interface 34 for controlling the control unit 31, a plurality of wheels 81 for mobilizing the cleaning device 100, and a container 50 for receiving objects from a space created between the guiding component 20 and the main cleaning component 10.

The user interaction interface 34 may include an input device (e.g., a touch screen, a voice command receiver, a keyboard, etc.) that is electrically coupled to the control unit 31 for transferring a control instruction (e.g., received from a user) to the control unit 31. The input device may include keys or a touch display screen to receive different keys corresponding to different functions and/or may include gears with different rotating keys correspond to the different functions (e.g., the touch display screen may be configured to display different modes, such as a cleaning mode, a self-cleaning mode, etc., for the users to choose from). Additionally, the user interaction interface 34 may be coupled to a remote electronic device (e.g., a computer, a mobile phone, a tablet, etc.) through one or more networks, such that a user may be able to remotely input a command to the cleaning device. As described in great details below, a user may input a first control instruction (e.g., using a voice command, a typed command, a selected option displayed on a display device of the interface, a remote electronic device, etc.) for controlling the cleaning device to perform a self-cleaning function or a surface cleaning function, or to turn the cleaning device on or off.

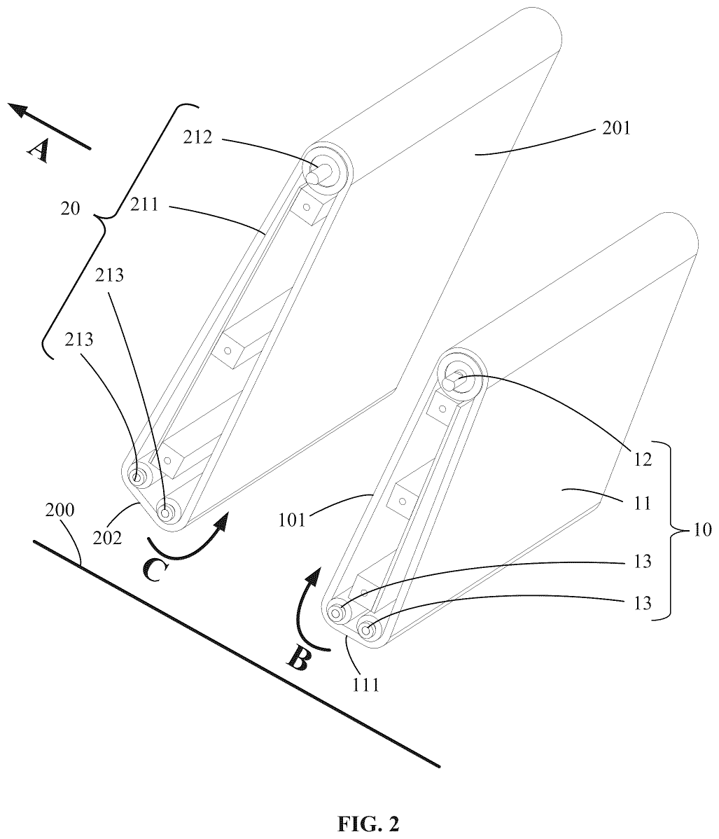

FIG. 2 is a diagram illustrating a main cleaning component and a guiding component of a cleaning device, in accordance with an example embodiment of the present disclosure. In some embodiments, the main cleaning component 10 may include a belt, such as a first rotatable conveyor belt 11, at least one first roller 12, and at least one first plane forming member 13 (e.g., two plane forming members 13, as shown in FIG. 2). The at least one first roller 12 and at least one first plane forming member 13 may support and provide tension to the first rotatable conveyor belt 11, such that the first conveyor belt 11 forms a conveyor structure and a plane 111 that contacts and presses against the surface 200 when the cleaning device 100 cleans the surface 200. In some embodiments, the first rotatable conveyor belt 11 may surround, and rotate around, each of the at least one first roller 12 and the at least one first plane forming member 13 in a clockwise direction (e.g., direction B shown in FIG. 2) when the cleaning device 100 moves forward (e.g., direction A). In some such embodiments, the second rotatable conveyor belt 211 may surround, and rotate around, each of the at least one second roller 212 and the at least one second plane forming member 213 in a counterclockwise direction (e.g., direction C shown in FIG. 2) when the cleaning device 100 moves forward (e.g., direction A). Having such a configuration, in some embodiments, when a bottom portion of the conveyor belt 11 (e.g., the plane 111) reaches an object (e.g., a trash), the clockwise rotation of the conveyor belt 11 (e.g., direction B) may guide, transport, or direct the object, which is on an area of the surface 200 in front of the conveyor belt 11, towards the space created between the main cleaning component 10 and the guiding component 20. Thereafter, the clockwise rotation of the conveyor belt 11 (e.g., direction B) and the counterclockwise rotation of the conveyor belt 211 (e.g., direction C) may guide, transport, or direct the object upward and toward the container 50 (e.g., through the created space between the main cleaning component 10 and the guiding component 20).

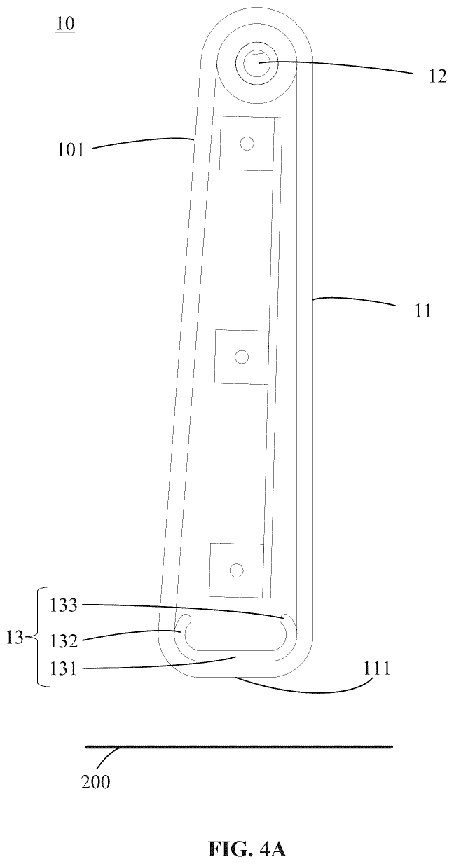

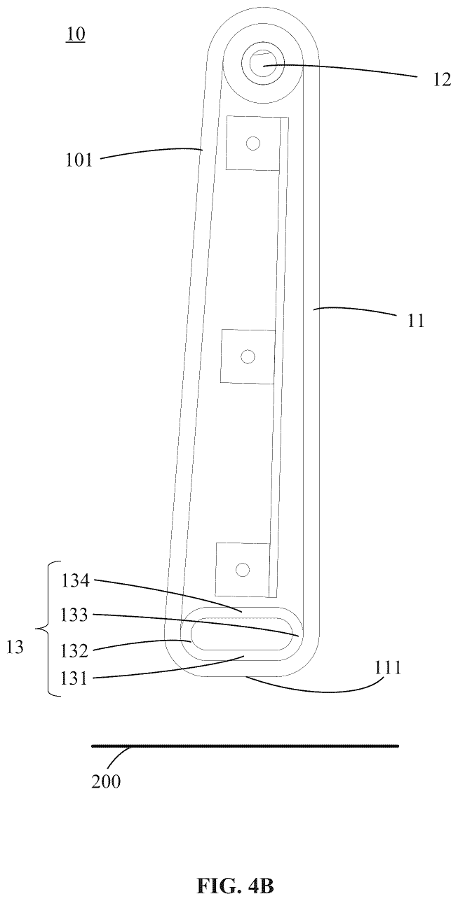

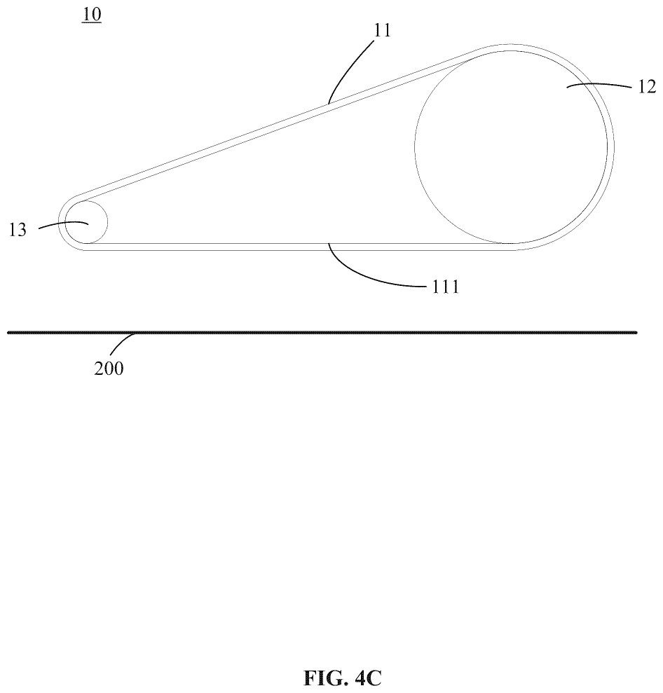

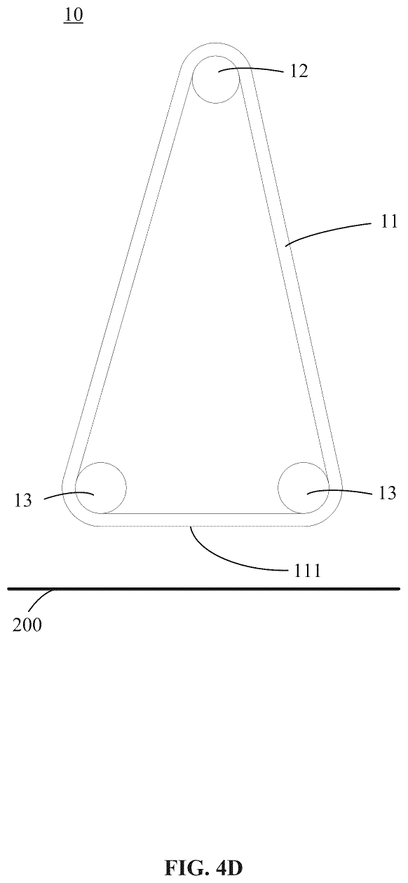

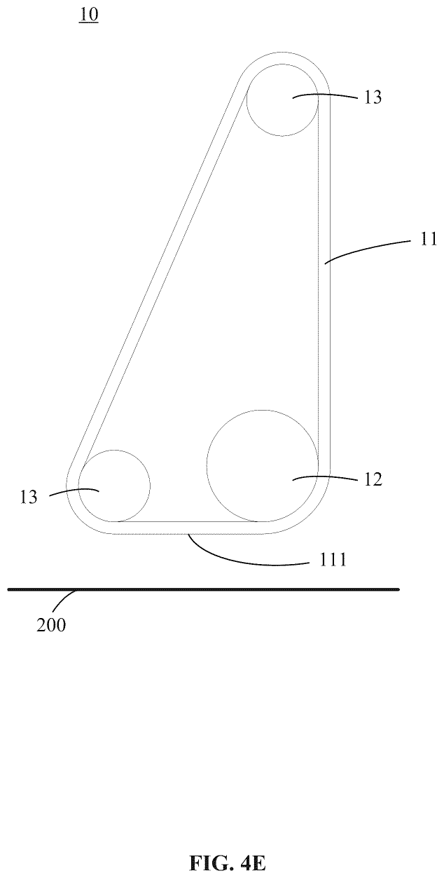

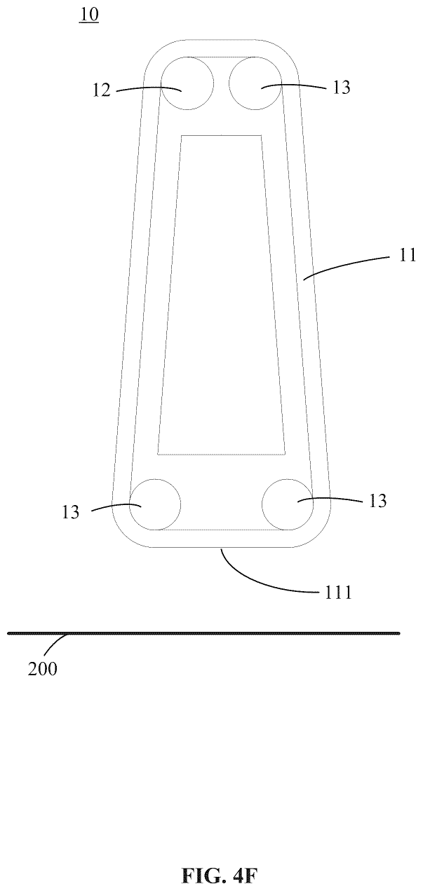

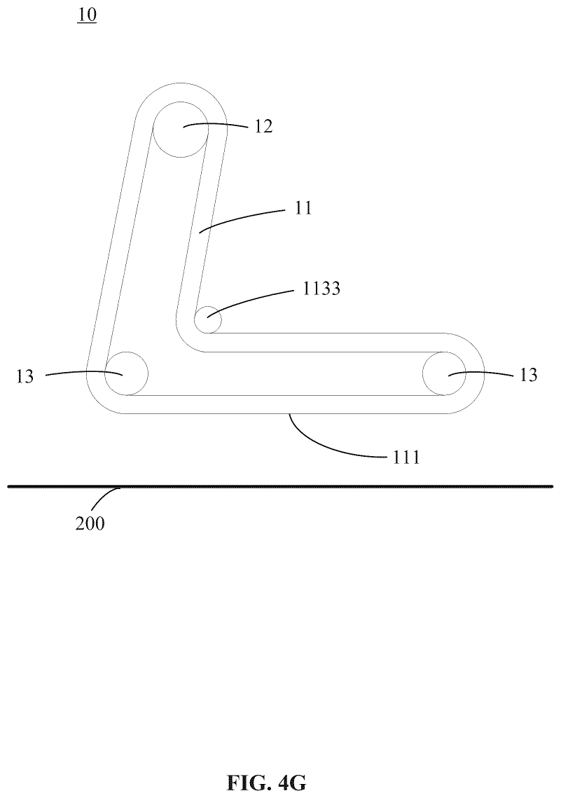

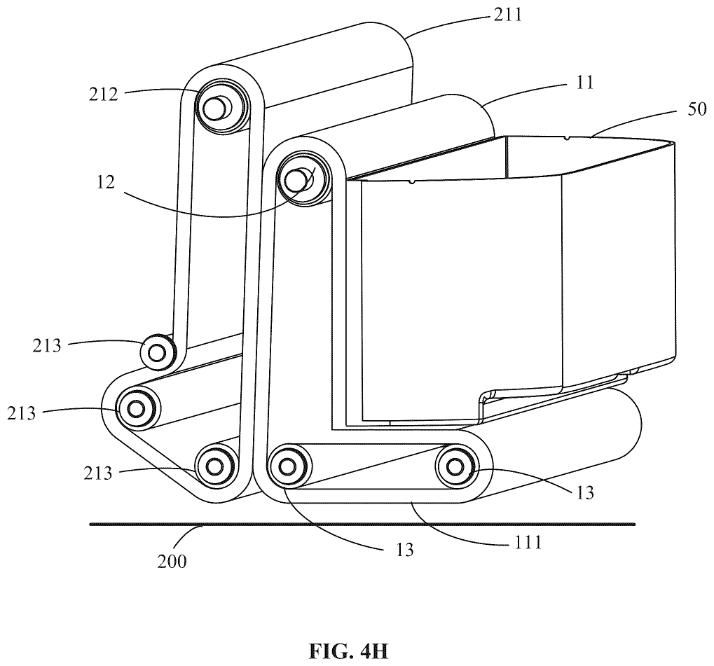

In some embodiments, the first roller 12 may bear most of the active rotational load to rotate the belt 11, thus an outer diameter of the first roller 12 may be sufficiently large to perform such rotational load. In some embodiments, each first plane forming member 13 may have an outer diameter less than an outer diameter of the first roller 12 (e.g., as shown in FIG. 4C), such that the first conveyor belt 11 may form a first plane 111 with a relatively large surface area for pressing against the surface 200. In some embodiments, the surface area of the plane 111 at a bottom portion of the conveyor belt 11 may be larger than or equal to a surface area of a top portion of the conveyor belt 11 as shown in FIG. 2.

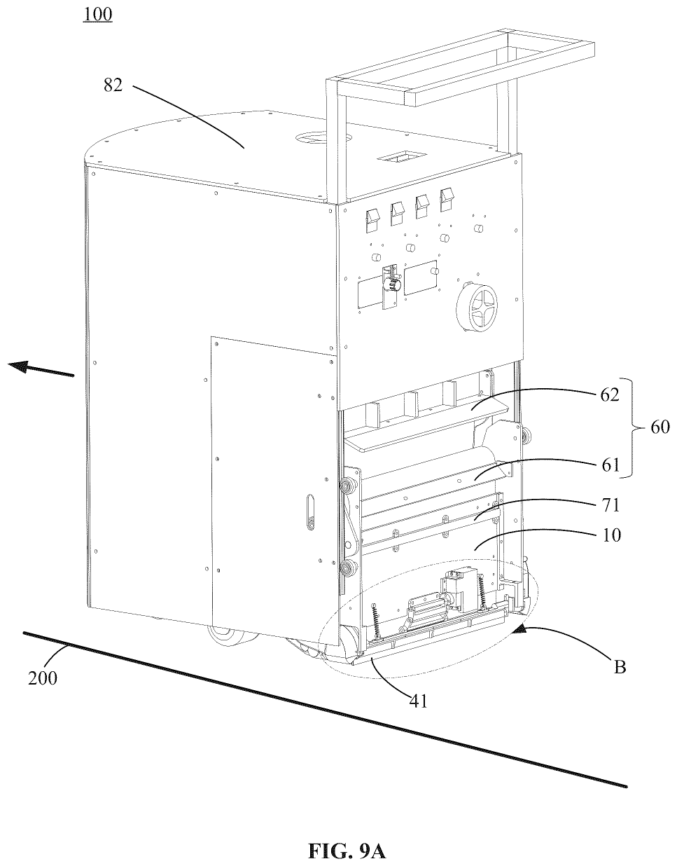

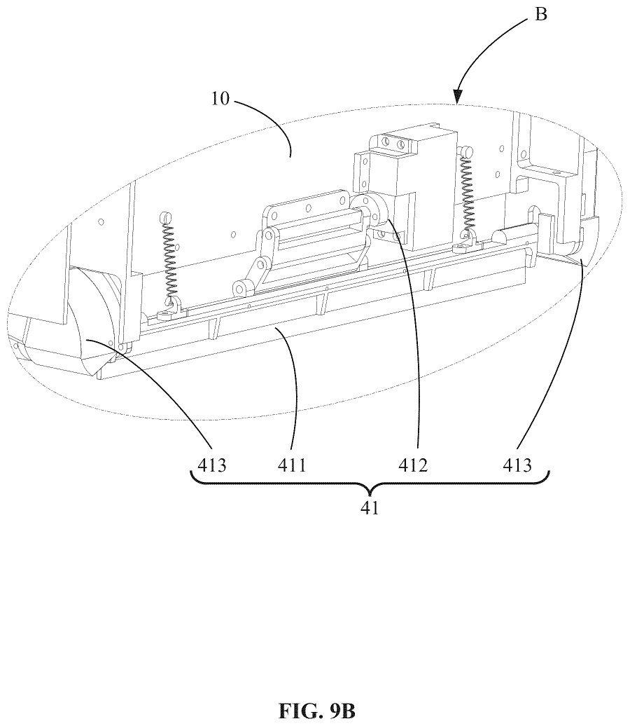

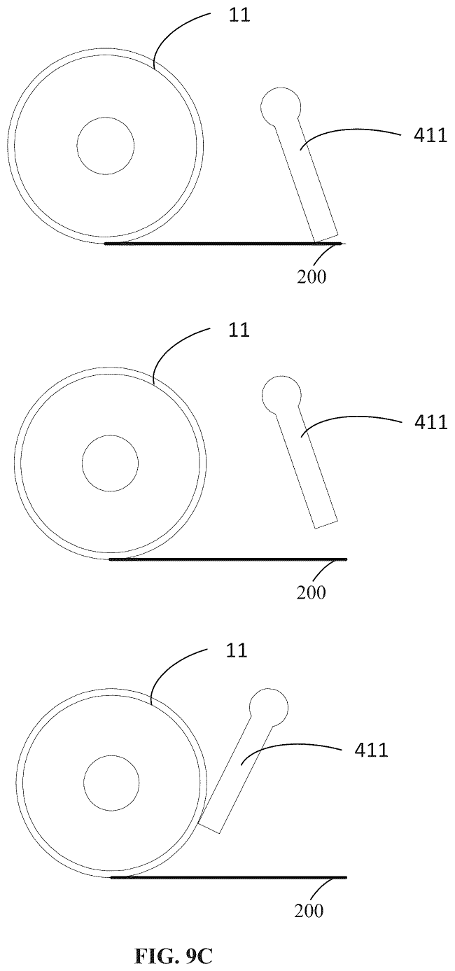

In some embodiments, a rotational axis of the first roller 12 and a rotational axis of each first plane forming member 13 may be perpendicular to the longitudinal direction (e.g., a vertical direction of the cleaning device as shown in FIG. 1A) of the cleaning device 100. In some embodiments, the rotational axis of the first roller 12 and the rotational axis of each first plane forming member 13 may be perpendicular to the direction of movement (e.g., direction of the displayed arrow as shown in FIG. 9A) of the cleaning device 100 on the surface 200.

In some embodiments, the guiding component 20 may also include a belt, such as a second rotatable conveyor belt 211, at least one second roller 212, and at least one second plane forming member 213 (e.g., two plane forming members 213, as shown in FIG. 2). The at least one second roller 212 and at least one second plane forming member 213 may support and provide tension to the second rotatable conveyor belt 211, such that the second conveyor belt 211 forms a conveyor structure and a plane (e.g., a tilted plane) 202 that contacts and presses against the surface 200 (e.g., at least partially) when the cleaning device 100 cleans the surface 200. The second rotatable conveyor belt 211 may surround, and rotate around, each of the at least one second roller 212 and the at least one second plane forming member 213 in a direction opposite to the rotating direction of the first rotatable conveyor belt 11 (e.g., in a counterclockwise direction). In some embodiments, the second conveyor belt 211 may be longer than the first conveyor belt 11 and may rotate faster in the opposite direction of the first conveyor belt 11.

In some such embodiments, if the first rotatable conveyor belt 11 rotates in a clockwise direction (e.g., direction B), the second rotatable conveyor belt 211 may rotate in a counterclockwise direction (e.g., direction C). In some such embodiments, the second rotatable conveyor belt 211 may rotate in a counterclockwise direction, such that an object on the surface 200 and under the second rotatable conveyor belt 211 may be guided towards the first rotatable conveyor belt 11 of the main cleaning component 10. With the first rotatable conveyor belt 11 and the second rotatable conveyor belt 211 rotating in opposite directions, the objects may be moved from the surface 200 and guided towards a container, such as the container 50 (e.g., FIG. 1B) to clean the surface, as the cleaning device 100 moves over the objects.

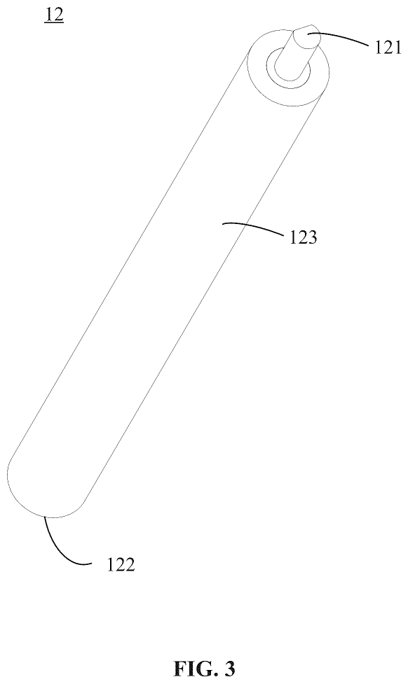

As described above, the main cleaning component 10 may include a first rotatable conveyor belt 11, at least one first roller 12, and at least one first plane forming member 13. FIG. 3 is diagram illustrating an example embodiment of a roller 12 of the main cleaning component 10, in accordance with an example embodiment of the present disclosure. In some embodiments, the roller 12 may include a shaft 121, a bearing 122, and a roller body 123. As will be described in more detail below, the roller 12 may be coupled to a motor (e.g., through a transmission belt) and may be rotated by a driving force of the motor. In an exemplary example, the roller 12 can be configured to have a length from 20 mm to 2000 mm, for example, 20 mm, 30 mm, 40 mm, 50 mm, 90 mm, 100 mm, 500 mm, 1000 mm, 1100 mm, 1900 mm, 2000 mm. The diagram of the roller 12 can be from 2 mm to 200 mm, for example, 2 mm, 3 mm, 4 mm, 10 mm, 11 mm, 15 mm, 20 mm, 50 mm, 100 mm, 150 mm, 190 mm, 200 mm. In some embodiments, any of the at least one second roller 212 may include a similar structure to the roller 12.

FIGS. 4A-4G are seven diagrams diagram illustrating example shapes of the main cleaning component generated by one or more rollers and plane forming members, in accordance with an example embodiment of the present disclosure. In the examples of FIGS. 4A-4C, the rotatable conveyor belt 11, one roller 12, and one plane forming member 13 are substantially similar to the rotatable conveyor belt 11, at least one first roller 12, and at least one first plane forming member 13, as described with reference to FIG. 2. Therefore, the details of the rotatable conveyor belt 11, roller 12, and plane forming member 13 will not be redescribed here again for the sake of brevity. The examples of the first plane forming member 13 in FIGS. 4A-4C differ from the embodiments of at least one first plane forming member 13 shown in FIG. 2 in that the plane forming member 13 in FIGS. 4A-4C include a different number/structure/shape/configuration of the plane forming member 13 from the embodiments of at least one first plane forming member 13 shown in FIG. 2.

In some embodiments, as shown in FIGS. 4A-4C, the plane forming members 13 of the cleaning device 100 may include only one plane forming member 13 (e.g., FIGS. 4A-4C). In some embodiments, the roller 12 and the plane forming member 13 may be spaced apart from each other along a height of the cleaning device 100 (e.g., as shown in FIGS. 4A and 4B). In some embodiments, instead of, or in conjunction with, the roller 12 and the plane forming member 13 being spaced apart along the height of the cleaning device 100, the roller 12 and the plane forming member 13 may be laterally spaced apart (e.g., as shown in FIG. 4C). In some embodiments, the plane forming member 13 may include one of a roller body, a rod body having an at least partially cylindrical outer surface, or a non-circular body having an at least partially arc-like outer surface. In some embodiments, the plane forming member 13 may have other shapes. It should be noted that shapes and positioning of the rollers and plane forming members may be different than the ones shown in these figures. For example, the number of plane forming members and their positioning in relation to each other within, or outside, the conveyor belt may be different than the ones shown in the figures.

In some embodiments, the plane forming member 13 may include a plate 131 and two arc-like members 132 and 133 positioned at opposite ends of the plate 131 (e.g., as shown in FIG. 4A), such that the plane forming member 13 may cause a bottom portion of the conveyor belt 11 near the surface 200 to form a plane 111 that may press against the surface 200 and mop/clean the surface 200. In some embodiments, the plane forming member 13 may include a plate 131, two arc-like members 132 and 133 positioned at opposite ends of the plate 131, and a connecting surface 134 may connect the two arc-like members 132 and 133 forming a hollow ring (e.g., as shown in FIG. 4B), such that the plane forming member 13 may cause a bottom portion of the rotatable conveyor belt 11 near the surface 200 to form a plane 111, which may press against and mop/clean the surface 200.

In some embodiments, the outer radius of the two arc-like members 132 and 133 may be different (e.g., the outer radii of the member 132 may be greater than or less than the outer radii of the member 133). In some embodiments, the two arc-like members 132 and 133, the plate 131, and the connecting surface 134 may be molded (e.g., via a molding injection, casting, stamping, etc.). In some embodiments, the two arc-like members 132 and 133, the plate 131, and the connecting surface 134 may be a hollow structure (e.g., a hollow ring) or a solid structure. In some embodiments, the number of one or more of the two arc-like members 132 and 133, the plate 131, and the connecting surface 134 may be more than one and may be positioned directly or diagonally below or above the roller 12. In some embodiments, the connecting surface 134 may be oblique, curved, not flat, or not parallel to the flat plane 111 or to the plate 131.

In some embodiments, the plane forming member 13 may be positioned laterally with respect to the roller 12, such that the plane forming member 13 and the roller 12 may cause a bottom portion of the rotatable conveyor belt 11 near the surface 200 to form a plane 111, which may press against and mop/clean the surface 200 (e.g., FIG. 4C).

FIGS. 4D and 4E are two diagrams illustrating other example embodiments of having more than one plane forming members in the main cleaning component, in accordance with an example embodiment of the present disclosure. The rotatable conveyor belt 11, roller 12, and two plane forming members 13 in FIGS. 4D and 4E may be substantially similar to that of shown in FIGS. 4A-4C. Therefore, the details of the rotatable conveyor belt 11, roller 12, and plane forming member 13 of FIGS. 4D and 4E will not be redescribed here again for the sake of brevity. The plane forming member 13 shown in FIGS. 4D and 4E differs from the plane forming member 13 shown in FIGS. 4A-4C in that the plane forming member 13 in FIGS. 4D and 4E may include different number/structure/shape/configuration of the plane forming member 13 shown in FIGS. 4D and 4E.

In some embodiments, the at least one plane forming member 13 of the cleaning device 100 may include two plane forming members 13. In some embodiments, the roller 12 and the two plane forming members 13 may be spaced apart from each other laterally. In some embodiments, the roller 12 and the two plane forming members 13 may be spaced apart from each other along a height of the cleaning device 100. In some embodiments, the roller 12 and the two plane forming member 13 may be spaced apart from each other laterally and along the height of the cleaning device 100. In some embodiments, the roller 12 may be spaced apart from, and positioned above, the two plane forming members 13 along the height of the cleaning device 100. In some such embodiments, the two plane forming members 13 may be spaced apart laterally, such that a bottom portion of the rotatable conveyor belt 11 near the surface 200 may partially wrap around the two plane forming members 13 to form a plane 111, which may press against and mop/clean the surface 200. The two plane forming members 13 may be positioned at two opposite ends of the plane 111 (e.g., as shown in FIG. 4D).

In some embodiments, the roller 12 may be spaced apart from, and positioned below, one of the two plane forming members 13 along the height of the cleaning device 100. In some such embodiments, the roller 12 may also be positioned laterally from the other one of the two plane forming members 13, such that a bottom portion of the rotatable conveyor belt 11 near the surface 200 may partially wrap around the roller 12 and the other one of the two plane forming members 13 to form a plane 111, which may press against and mop/clean the surface 200. In some such embodiments, the roller 12 and the other one of the two plane forming members 13 may be positioned at two opposite ends of the plane 111 (e.g., as shown in FIG. 4E).

FIGS. 4F and 4G are two diagrams illustrating other example embodiments of having more than one plane forming members in the main cleaning component, in accordance with an example embodiment of the present disclosure. The rotatable conveyor belt 11, roller 12, and plane forming member 13 shown in FIGS. 4F and 4G may be substantially similar to that of the rotatable conveyor belt 11, roller 12, and plane forming member 13 shown in FIGS. 4A-4E. Therefore, the details of the example rotatable conveyor belt 11, roller 12, and plane forming member 13 of FIGS. 4F and 4G will not be redescribed here again for the sake of brevity. The exemplary plane forming member 13 shown in FIGS. 4F and 4G, however, differs from the exemplary plane forming member 13 shown in FIGS. 4A-4E in that the plane forming member 13 in FIGS. 4F and 4G may include a different number/structure/shape/configuration of the plane forming member 13 from the example plane forming member 13 as shown in FIGS. 4A-4E.

In some embodiments, the at least one plane forming member 13 of the cleaning device 100 may include three plane forming members in which one of the three plane forming members 13 may be positioned laterally with respect to the roller 12. In some such embodiments, the other two of the three plane forming members 13 may be positioned below and spaced apart from the roller 12 along a height of the cleaning device 100, such that a bottom portion of the rotatable conveyor belt 11 near the surface 200 may partially wrap around the two plane forming members 13 to form a plane 111, which may press against and mop/clean the surface 200 (e.g., as shown in FIG. 4F). Although, in the embodiments shown in FIGS. 4D-4G, the roller 12 is shown to be above one or more the plane forming members 13 along the height of the cleaning device, in some other embodiments, the roller 12 may be below one or more of the plane forming members 13 along the height of the cleaning device.

In some embodiments, the at least one plane forming member 13 of the cleaning device 100 may include three plane forming members (e.g., two plane forming members 13 and one plane forming member 1133), which may be positioned below and spaced apart from the roller 12 along a height of the cleaning device 100. In some such embodiments, as shown in FIG. 4G, two plane forming members 13 and the roller 12 may be positioned within the rotatable conveyor belt 11 and one plane forming member 1133 may be positioned outside the rotatable conveyor belt 11. In some embodiments, the roller 12 and the two plane forming members 13 positioned within the conveyor belt 11 may be spaced apart such that a bottom portion of the conveyor belt 11 near the surface 200 may form a plane 111, which may be pressed against the surface 200, while the other one plane forming member 1133 outside the conveyor belt 11 may be positioned, such that a recess (e.g., a bent) is applied to one side of the conveyor belt 11.

In some embodiments, the roller 12 and the two plane forming members 13 positioned within the conveyor belt 11 and the one plane forming member 1133 positioned outside the conveyor belt 11 may form an “L-shaped” rotatable conveyor belt 11 (e.g., as shown in FIG. 4G). In some such embodiments, the outline of a recess formed by the plane forming member 1133 that is positioned outside the first conveyor belt 11 may have a curvature substantially similar to a capital letter “L” as shown in FIG. 4G. In some embodiments, with reference to the above example embodiments in FIG. 4G, the outline of the recess formed by the plane forming member 1133 that is positioned outside the first conveyor belt 11 may have a much greater or less radius than that of the above example embodiments (e.g., “L-shaped”) shown in FIG. 4G. In some other embodiments, the “L-shaped” conveyor belt may include any other shape that is similar to, or different from, the letter “L” shape, and may not be limited to the shapes provided in the present disclosure. For example, in some embodiments, one or more plane forming members that are located outside the conveyor belt 11 may create a curve (without having an angle) in one side of the conveyor belt. In some embodiments, instead of, or in conjunction with, the plane forming member 1133, other components, such as the container 50, may be positioned on top of the plane 111 and cause the conveyor belt 11 to form an L shape or any other shape (e.g., depending on the form/shape of the bottom portion of the component, such as the bottom portion of the container 50), as shown below with reference to FIG. 4H.

The two plane forming members 13 may be positioned along a height of the cleaning device 100, such that a bottom portion of the conveyor belt 11 near the surface 200 may partially wrap around the two plane forming members 13 to form the plane 111, which may press against and mop/clean the surface 200 (e.g., as shown in FIG. 4G). It should be noted that even though the roller 12 is shown to be positioned above the other three plane forming members 13 and 1133 in FIG. 4G, in some embodiments, the roller 12 may be positioned anywhere else within the conveyor belt 11 (e.g., the roller 12 and any of the two plane forming members 13 within the conveyor belt may swap positions). For example, the roller 12 may switch its place with any one of the two plane forming members 13 that are positioned at the two opposite ends of the plane 111 in FIG. 4G. In some embodiments, the roller 12 may be spaced apart from any number of the plane forming members 13 to form the rotatable conveyor belt 11 having different shapes, such as being triangularly-shaped, trapezoidally-shaped, parallel quadrilaterally-shaped, etc.

FIG. 4H is a diagram illustrating another example shape of the main cleaning component generated by one or more rollers, plane forming members, and/or other components, in accordance with an example embodiment of the present disclosure. In some embodiments, as shown in FIG. 4H, instead of, or in conjunction with, having a plane forming member (e.g., plane forming member 1133, as shown in FIG. 4G) outside the conveyor belt 11 to bend a side of the conveyor belt (e.g., to make a recess in one side of the conveyor belt 11), a container, such as the container 50, may be positioned (e.g., partially) on top of the conveyor belt 11 to make a recess (e.g., a bent) in one side of the conveyor belt 11. As shown in FIG. 4H, the container 50 has been placed on the conveyor belt 11, such that the container 50, the plane forming members 13 inside the conveyor belt, and the roller 12 have caused the bottom portion of the conveyor belt 11 to form the plane 111 (e.g., and caused the whole conveyor belt 11 to form an “L” shape).

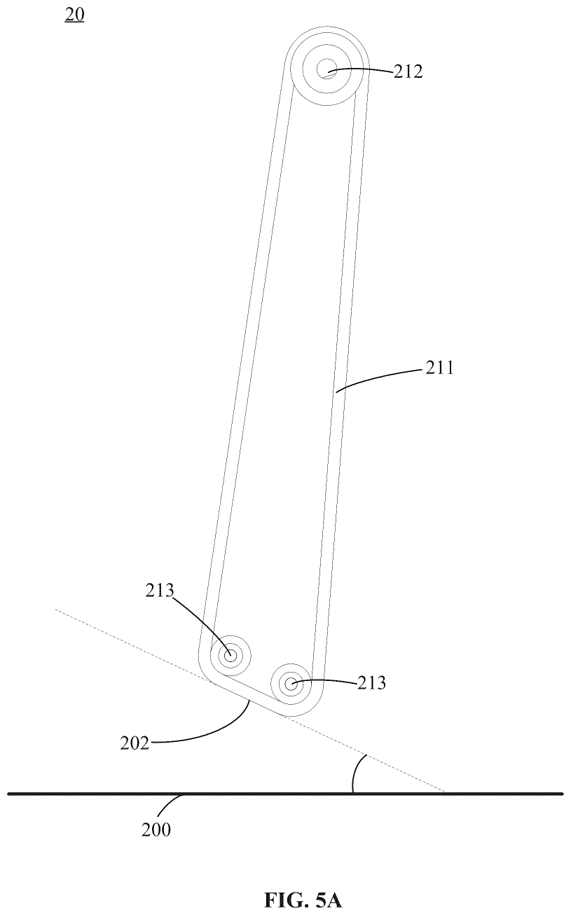

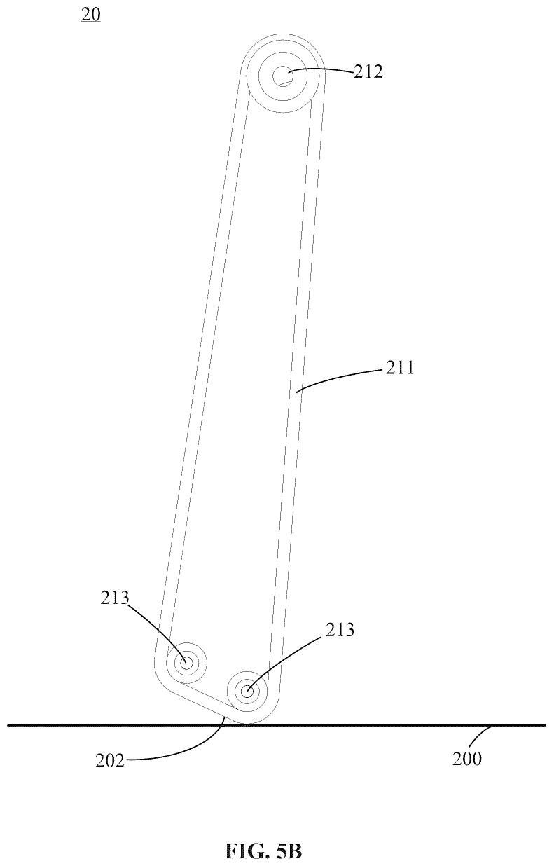

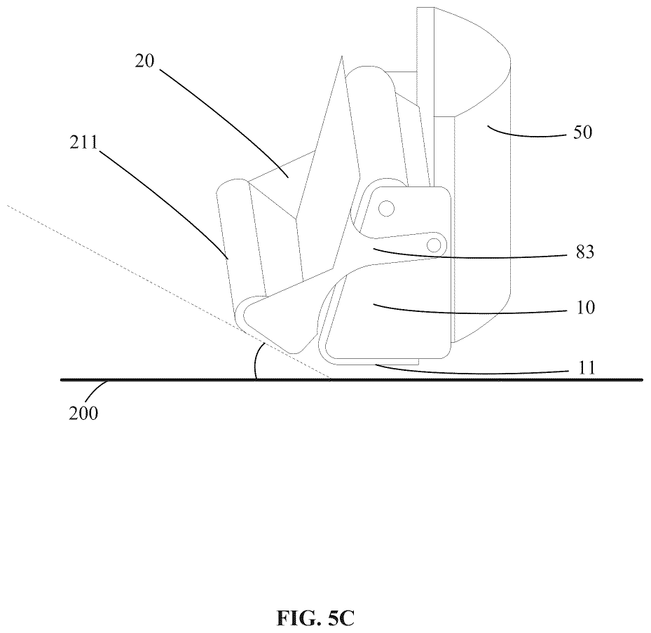

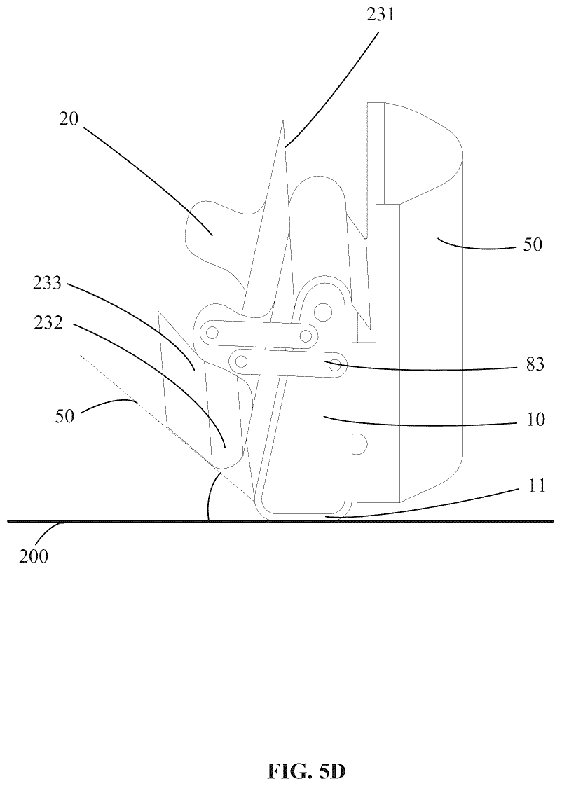

It should be noted that, even though in the example illustrated in FIG. 4H, one of the plane forming members 213 of the guiding component 20 is positioned outside the conveyor belt 211 of the guiding component 20, in some other embodiments, the plane forming member 213 outside the conveyor belt may not exist. For example, as shown in FIGS. 5A and 5B, a guiding component 20 may include a roller 212 and two plane forming members 213 all of which may be positioned within the conveyor belt 211 (e.g., to form a triangular shape).

In some other embodiments, one or more other components of the cleaning device 100 may replace the container 50 (e.g., may be positioned over the plane 111 of the conveyor belt 11). As discussed before, in some other embodiments, the number and/or positions of the roller and the plane forming members within and/or outside the conveyor belt 11 may be different from the number and positions of these elements, as shown in the example embodiments/figures.

In some embodiments, the first roller 12 and the at least one plane forming member 13 may not be positioned to be aligned with each other (e.g., along the height of the cleaning device 100) as long as the front side 101 (e.g., as shown in FIG. 2) of the main cleaning component 10 and the back side 201 (e.g., as shown in FIG. 2) of the guiding component 20 are tilted at a similar angle (e.g., the two components are parallel to each other). In an exemplary example, the angle can be configured to be from 5 degrees to 90 degrees, with an accuracy/precision of +0.1 degree, for example, 5, 6, 7, 10, 15, 20, 25, 30, 35, 40, 45, 50, 60, 75, 80, 85, 89, 89.5, 90 degrees.

FIGS. 5A and 5B are two diagrams illustrating example embodiments of a guiding component of the cleaning device, in accordance with an example embodiment of the present disclosure. As discussed above, the guiding component 20 may include a rotatable conveyor belt 211, at least one roller 212, and at least one plane forming member 213. In FIGS. 5A and 5B, the example rotatable conveyor belt 211, a second roller 212, and two plane forming member 213 are substantially similar to that of the example rotatable conveyor belt 11, the roller 12, and the two plane forming members 13 shown in FIGS. 4D and 4E. Therefore, the details of the rotatable conveyor belt 211, roller 212, and two plane forming members 213 will not be redescribed here again for the sake of brevity. The example plane forming member 213 in FIGS. 5A and 5B differs from the example plane forming member shown in FIGS. 4D-4E in that the plane forming member 13 in FIGS. 5A and 5B may include different number/structure/shape/configuration of the plane forming member 213.

In some embodiments, the roller 212 may include a shaft, a bearing, and a roller body similar to that of the roller 12 shown in FIG. 3. In some embodiments, the plane forming member 213 may include one of a roller body, a rod body having an at least partially cylindrical outer surface, or a non-circular body having an at least partially arc-like outer surface. In some embodiments, the roller 212 and the plane forming member 213 may be laterally spaced apart. In some embodiments, the roller 212 and the plane forming member 213 may be spaced apart from each other along a height of the cleaning device 100.

In some embodiments, the at least one plane forming member 213 may include two plane forming members 213. The roller 212 may be spaced apart and positioned above the two plane forming members 213 along the height of the cleaning device 100 to cause the second rotatable conveyor belt 211 form a triangular shape. In some embodiments, the roller 212 may be spaced apart and positioned above the two plane forming members 213 along the height of the cleaning device 100, such that a bottom portion of the second rotatable conveyor belt 211 near the surface 200 may form an induction slope 202. In some embodiments, the induction slope 202 may be at an angle (e.g., acute angle) with respect to the surface 200 (e.g., as shown in FIG. 5A) and extend in a direction away from the conveyor belt 11 of the main cleaning component 10 and the surface 200, such that the induction slope 202 may guide object(s) of different sizes towards the rotatable conveyor belt 11 of the main cleaning component 10. In an exemplary example, the angle of the induction slope can be configured to be from 0.1 degrees to 89.9 degrees, with an accuracy/precision of ±0.1 degree, for example, 0.1, 0.5, 1, 5, 6, 7, 10, 15, 20, 25, 30, 35, 40, 45, 50, 55, 60, 70, 80, 85, 82.5, 85, 87.5, 89, 89.5, 89.9 degrees. In some embodiments, the guiding component 20 in FIG. 5B may include a plane 202 (e.g., similar to the plane 202 of the guiding component of FIG. 5A) that may be partially pressed against the surface 200 for cleaning the surface, for example, in addition to guiding the objects towards the space between the main cleaning component 10 and the guiding component 20 and into the container 50. That is, in some embodiments, the plane 202 may have a distance to the surface 200 when the cleaning device is in cleaning mode (e.g., as shown in FIG. 5A). Such a distance may be generated when the guiding component 20 is moving over the objects, or it may be configured as default, or it may be adjusted by an operator of the device. In some embodiments, such as in FIG. 5B, part of the conveyor belt 211 of the guiding component 20 may be in contact with the surface 200 when the cleaning device 100 is cleaning the surface 200.

In some embodiments, the roller 212 may be spaced apart and positioned above the two plane forming members 213 along the height of the cleaning device 100, such that a second portion of the conveyor belt 211 near the surface 200 may form a plane to press against the surface and to clean (e.g., sweep) the objects (e.g., garbage) on the surface 200. As will be described in more detail below, the guiding component 20 may be movably coupled to the main cleaning component 10, such that when the objects with different sizes move through a space created between the guiding component 20 and the main cleaning component 10, a size of the space (e.g., the width and/or height and/or length of the space) between the guiding component 20 and the main cleaning component 10 may automatically adjust to facilitate the movement of the objects through the space. For example, as the garbage moves upward through the created space, the back side of the guiding component may move further away from (or closer to) the front side of the main cleaning component. Similarly, the back side of the guiding component, as the garbage moves through the created space, may move further up or down, or to the left or to the right.

FIGS. 5C and 5D are two diagrams illustrating other example embodiments of a guiding component of the cleaning device, in accordance with an example embodiment of the present disclosure. In some embodiments, the guiding component 20 may include a second rotatable conveyor belt 211 and one or more rollers. In some such embodiments, a first portion of the second rotatable conveyor belt 211 near the surface 200 may form an induction slope 202. In some embodiments, the induction slope 202 may be at an angle (e.g., acute angle) with respect to the surface 200 (e.g., as shown in FIG. 5C), such that the induction slope 202 may guide (e.g., sweep) an object towards the first rotatable conveyor belt 11 of the main cleaning component 10. In an exemplary example, the angle of the induction slope can be configured to be from 0.1 degrees to 89.9 degrees, with an accuracy/precision of ±0.1 degree, for example, 0.1, 0.5, 1, 5, 6, 7, 10, 15, 20, 25, 30, 35, 40, 45, 50, 55, 60, 70, 80, 85, 82.5, 85, 87.5, 89, 89.5, 89.9 degrees.

In some embodiments, the guiding component 20 may not necessarily have a conveyor belt, such as the conveyor belt 211, as shown in FIG. 5C. For example, in some embodiments, the guiding component 20 may only include a plate 231 that is coupled to a bottom portion (or plane) 233 of the guiding component 20 via a curved member 232 (e.g., as shown in FIG. 5D). In some embodiments, the plate 231 and the curved member 232 may provide an induction slope 202 that guides the object under the plane 233 and toward the first conveyor belt 11, as the cleaning device 100 moves over the object. In some embodiments, the weight of the plate 231 may press the objects against the first conveyor belt 11 to prevent the objects from falling and to facilitate the upward movement of the objects through the space created between the main cleaning component 10 and the guiding component 20.

In some embodiments, the plate 231 may have other applications in addition to guiding the objects toward the main cleaning component 10 or moving the objects, while acting in concert with the main cleaning component 10, toward the container 50. For example, in some embodiments, the guiding component 20 may also be used to clean the main cleaning component 10, for example, when the cleaning device is in a self-cleaning mode. In another embodiments, the main cleaning component 10 may be used to clean the guiding component 20 when the plate 231 contacts the main cleaning component 10. In another embodiments, the main cleaning component 10 may be used to clean the guiding component 20 when the plate 231 contacts the main cleaning component 10. Additionally, the guiding component may include a bottom portion that cleans/mops the surface 200. For example, the bottom portion of the guiding component 20 may include a roller brush or a disk brush made of, for example, a cleaning cloth, a flocking cloth, or a combination of a brush and a cleaning cloth or a flocking cloth.

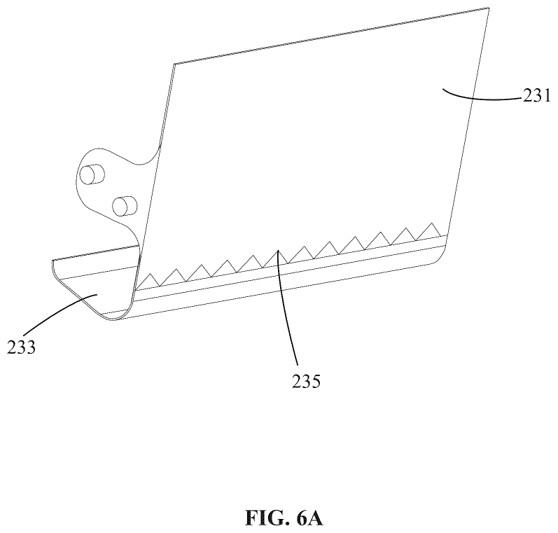

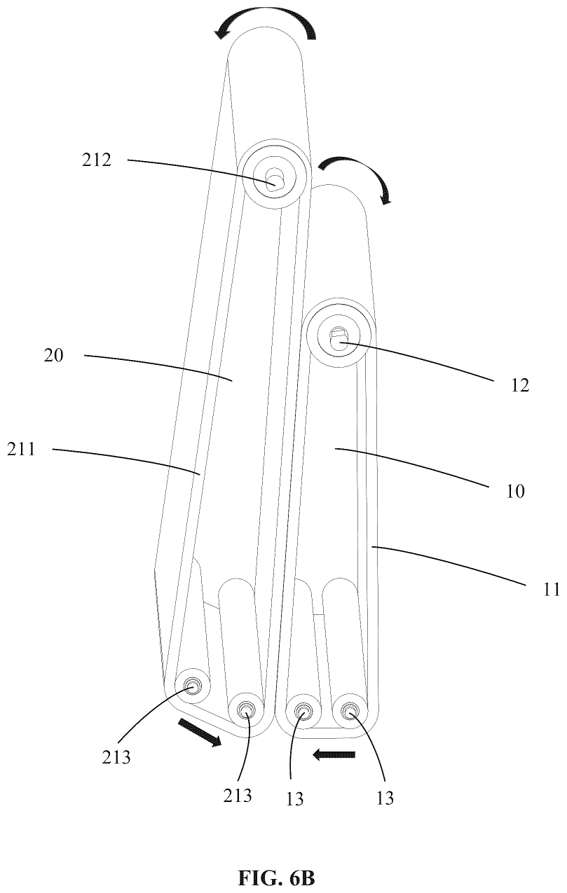

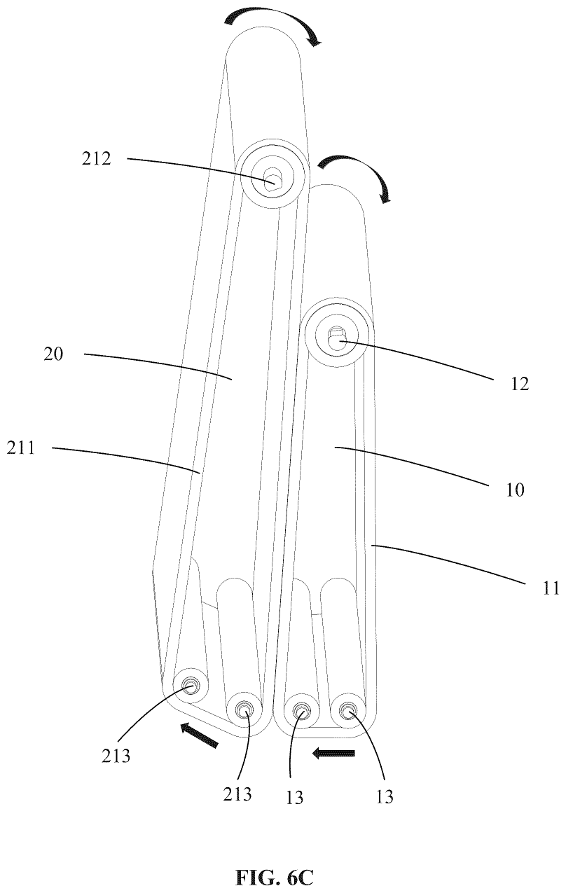

FIG. 6A-6C are three diagrams illustrating other utilizations of the guiding component, in accordance with an example embodiment of the present disclosure. In some embodiments, the guiding component 20 may include additional members/structures that may help the cleaning device 100 to self-clean its main cleaning component 10. For example, in some embodiments, the back side of the guiding component 20 may include a plate 231 that may scrub against the rotating conveyor belt 11 of the main cleaning component 10 to clean the conveyor belt 11.

In some embodiments, the surface of the plate 231 may have different shapes that may facilitate such a self-cleaning function. For example, as shown in FIG. 6A, the plate 231 may include a flexible serrated member 235 on its surface (or as part of its surface) that may scrub against the rotating conveyor belt 11 in FIG. 5D (e.g., when the conveyor belt rotates counterclockwise). In some embodiments, the flexible serrated member 235 may be made of soft material and may include several toothed portions. The flexible serrated member 235 may be inclined upward, such that the friction between the conveyor belt 11 and the plate 231, when the conveyor belt 11 rotates counterclockwise (e.g., when the cleaning device is in a self-cleaning mode), is much greater than the friction between the conveyor belt 11 and the plate 231 when the conveyor belt 11 rotates clockwise (e.g., when the cleaning device is in a cleaning mode).

In some other embodiments, the plate 231 may have other members (or surfaces) in addition to, or instead of, the serrated surface that may facilitate cleaning the conveyor belt 11. For example, the plate 231 may have a surface that includes a plurality of convex portions and a plurality of concave portions, where the pluralities of convex and concave portions of the plate 231 may scrub against the rotating conveyor belt 11 to clean the conveyor belt. In other embodiments, the plate 231 may have a wedge-shaped protrusion (or other types of protrusion or raised members) that scrubs against the rotating conveyor belt 11 to clean the conveyor belt.

In some embodiments, in order to achieve efficient cleaning of the main cleaning component 10, when the guiding component 20 also has a conveyor belt, such as conveyor belt 211, the directions of rotation of the conveyor belt 11 of the main cleaning component 10 and the conveyor belt 211 of the guiding component 20 may be different for different types of cleaning (e.g., surface cleaning or self-cleaning). As discussed above, the second rotatable conveyor belt 211 of the guiding component 20 may wrap and rotate around the roller 212 (and the plane forming member(s) 213), and together with the conveyor belt 11 of the main cleaning component may move the objects upward and towards the container 50.

When each of the main cleaning component 10 and the guiding component 20 includes a conveyor belt, a control unit of the cleaning device 100 (e.g., the control unit 31, as shown in FIG. 1B) of some embodiments may control a motor associated with each conveyor belt (e.g., or one motor that is associated with both conveyor belts) to rotate each conveyor belt (e.g., via one or more rollers of each conveyor belt) in a different direction based on in which mode the cleaning device is.

For example, when the cleaning device is in the (surface) cleaning mode, as shown in FIG. 6B, the control unit (not shown in this figure) may cause the conveyor belt 11 of the main cleaning component 10 to rotate in a clockwise direction and cause the conveyor belt 211 of the guiding component 20 to rotate in a counterclockwise direction. In other words, in the cleaning mode of the cleaning device 100, the two conveyor belts (e.g., conveyor belts 11 and 211) of the main cleaning component 10 and the guiding component 20 may rotate in opposite direction to facilitate the movement of objects on the surface toward the container 50. In some such embodiments, the control unit may configure the drying component to dry the surface. In some such, the control unit may configure the liquid outlet component to direct liquid toward the surface and/or the main cleaning component and the guiding component.

Conversely, when the cleaning device is in the self-cleaning mode, as shown in FIG. 6C, the control unit (not shown in this figure) may cause the conveyor belt 11 of the main cleaning component 10 to rotate in a clockwise direction and cause the conveyor belt 211 of the guiding component 20 to rotate also in the clockwise direction. In other words, in the self-cleaning mode of the cleaning device 100, the two conveyor belts (e.g., conveyor belts 11 and 211) of the main cleaning component 10 and the guiding component 20 may rotate in the same direction to increase the friction between the surfaces of the two conveyor belts (e.g., the backside of the conveyor belt 211 may rub against the front side of the conveyor belt 11) and hence, cleaning the conveyor belt 11 more efficiently. In some embodiments, a speed (e.g., linear speed) of rotation of the conveyor belt 211 may be different from a speed (e.g., linear speed) of rotation of the conveyor belt 11. In some embodiments, the rotation speed of the two conveyor belts (e.g., conveyor belts 11 and 211) may be adjustable (e.g., by a user).

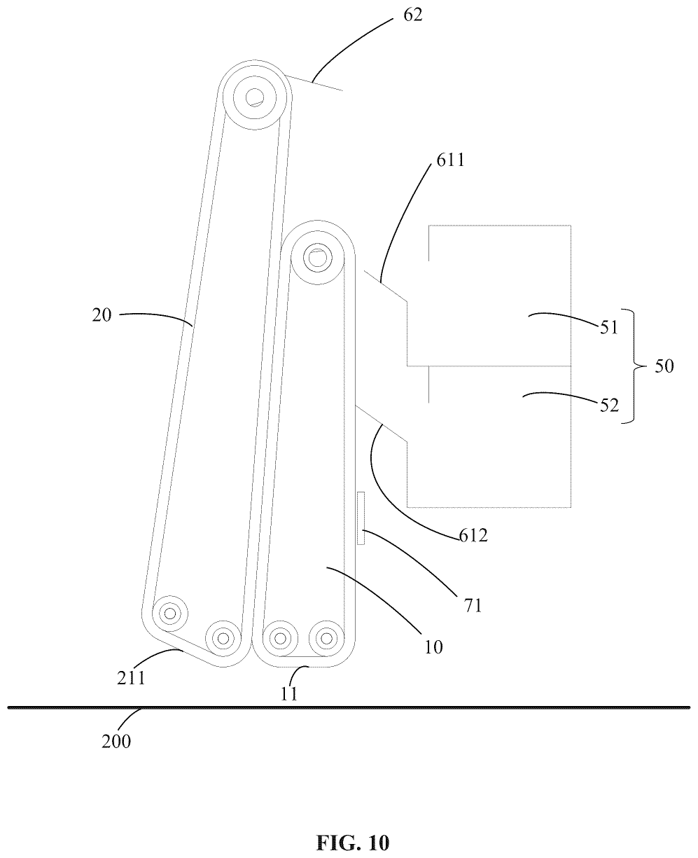

In some embodiments, a liquid outlet component, such as liquid outlet component 71 (shown in FIG. 10) and/or storage container 72 (shown in FIG. 1B), may direct cleaning liquid toward one or both conveyor belts (e.g., or the plate of the guiding component and/or the conveyor belt of the main cleaning component) when the cleaning device is in the self-cleaning mode to better clean these components. For example, the control unit 31 may control the liquid outlet component 71 to direct a cleaning liquid to at least one of the conveyor belt 211 or the conveyor belt 11 when the cleaning device 100 is in the self-cleaning mode.

In addition to the guiding component 20 scrubbing against the main cleaning component 10, in some embodiments, a scraper (e.g., such as the scraper 411 which will be discussed in great detail below, e.g., with reference to FIG. 10) that is positioned behind the main cleaning component 10 along a moving direction of the cleaning device, may be configured to move forward (e.g., inward) to scrape against the conveyor belt 11 to clean the conveyor belt 11 when a self-cleaning function of the cleaning device 100 is activated. More details about how the scraper may clean the conveyor belt 11 are described below, with reference to FIG. 9C.

As discussed above, the second rotatable conveyor belt 211 of the guiding component 20 may wrap and rotate around the roller 212 and the plane forming member(s) 213, for example, in a counterclockwise direction, such that an induction slope 202 of the second rotatable conveyor belt 211 may guide the objects on the surface 200 towards the main cleaning component 10, and together with the conveyor belt 11 of the main cleaning component may move the objects towards a space between the main cleaning component 10 and the guiding component 20 (e.g., as shown in FIG. 2) and clean (e.g., mop) the surface 200. The objects guided to the space may then be further guided to a container 50 of the cleaning device 100. The first rotatable conveyor belt 11 of the main cleaning component 10 may rotate around the roller 12 and the plane forming member 13, for example, in a clockwise direction, such that a plane 111 of the first rotatable conveyor belt 11 may further carry the objects from the surface 200 towards a space between the main cleaning component 10 and the guiding component 20 (e.g., as shown in FIG. 2) and clean (e.g., mop) the surface 200. The objects guided to the space may then be further guided towards the container 50. In some embodiments, the main cleaning component 10 and the guiding component 20 may be rotatably connected to one another via one or more connecting frames (e.g., connecting frame 83 as shown in FIGS. 5C and 5D).

In some embodiments, the space between the main cleaning component 10 and the guiding component 20 may be formed between a back side (e.g., back side 201 shown in FIG. 2) of the conveyor belt 211 and a front side (e.g., front side 101 shown in FIG. 2) of the conveyor belt 11. The back side of the guiding component 20 and the front side of the main cleaning component 10 may be adjacent such that to oppositely face each other (e.g., in parallel with one another), and at an angle with respect to the surface 200. The object within the space between the two components may be further guided/transferred toward the container 50 (e.g., as shown in FIG. 1A), for example, by being clamped in the space formed between the back side of the second conveyor belt 211 and the front side of the first conveyor belt 11, as the cleaning device 100 moves over the object on the surface 200.

In some embodiments, the front side (e.g., 101 in FIG. 2) of the first conveyor belt 11 may extend obliquely, with respect to the surface 200, in a first direction from a portion of the main cleaning component 10, proximate to the surface 200, towards another portion of the main cleaning component 10, distal from the surface 200. In some embodiments, the back side (e.g., 201 in FIG. 2) of the second conveyor belt 211 may extend obliquely, with respect to the surface 200, in the first direction from a portion of the guiding component 20, proximate to the surface 200, towards another portion of the guiding component 20, distal from the surface 200. In some embodiments, the first direction may refer to a direction towards a rear side of the cleaning device 100. In other embodiments, the front side (e.g., front side 101 in FIG. 2) and the back side (e.g., back side 201 in FIG. 2) may extend obliquely, with respect to the surface 200, in a second direction, which may refer to a direction away from a rear side of the cleaning device 100. It should be noted that the manner in which the front side (e.g., 101) and the back side (e.g., 201) may extend (e.g., tilted) is not limited to the embodiments provided herein.

In some embodiments, a size (e.g., width, height, length) of the space formed between the back side of the plate 231 (or the back side of the second conveyor belt 211) and the front side of the first conveyor belt 11 (e.g., front side 101 in FIG. 2) may be adjusted to accommodate object(s) of different sizes to be passing through the space. In some such embodiments, the guiding component may move (or swing) backward (and upward) to automatically adjust the space.

The object guided within the space, as described above, may be further guided upward, for example, through the space formed between the back side of the second conveyor belt 211 and the front side of the first conveyor belt 11, and toward the container 50 (e.g., as shown in FIG. 1A). Such guiding of the object may obviate the need, but instead provide an option, for an air blowing/suctioning unit (e.g., a powered fan) to guide the object towards the container 50, and thereby reducing/removing excessive and loud noise generated by such units (e.g., by obviating the need for having extra air suctioning/blowing engines).

In some embodiments, as discussed above, the plane 111 that contacts and presses against the surface 200 may be formed by a bottom portion of the first conveyor belt 11 near the surface 200. In some embodiments, the plane 111 may be a horizontally flat plane, such as the plane 111, pressed against the surface 200 with the maximum amount of surface area of the first conveyor belt 11 for efficiently guiding/conveying objects (e.g., garbage). In some such embodiments, the surface area of the first conveyor belt 11 that forms the plane 111 may be maximized by having the surface area of the first conveyor belt 11 forming the plane 111 being greater than a surface area of a top portion of the first conveyor belt 11 (e.g., near a top-most portion of the cleaning device), which may also facilitate miniaturization of the cleaning device 100.

In some embodiments, the plane 111 formed at the bottom portion of the cleaning device 100 may press against the surface partially due to the weight of the main cleaning component 10 and partially due to a weight shifting of the guiding component 20 onto the main cleaning component 10. In some embodiments, additional external force(s) (e.g., tensile/spring force, gravitational force, etc.) may be applied to the main cleaning component to add to the pressing force of the main cleaning component 10 against the surface. For example, in some embodiments, one or more weights may be deployed on top of the main cleaning component 10 to push this component further against the surface. Instead of, or in conjunction with, the weight(s), in some embodiments, one or more springs may be deployed at the top of the main cleaning component to generate a tensile force against the surface.

In some embodiments, the second conveyor belt of the guiding component 20 may also have a bottom side that forms a second plane, a part of which may press against the surface. In some such embodiments, a surface area of the first plane associated with the main cleaning component 10 may be greater than a surface area of the second plane associated with the guiding component 20. While the first plane (e.g., of the main cleaning component's conveyor belt) presses against the surface such that the entire surface of the first plane is in contact with the surface, in some embodiments, the second plane (e.g., of the guiding component's conveyor belt) may be partially in contact with the surface. As described above and below, this may occur, in some embodiments, when the second plane has an induction slope (relative to the surface) that may facilitate drawing in of the object(s), for example, toward the center of the cleaning device 100 where the main cleaning component 10 is.

In some embodiments, the induction slope may be tilted such that it extends in a direction away from the main cleaning component (and also from the surface). This way, the objects that have different sizes may be easily removed from the surface. For example, after the objects having different sizes are pulled in through the induction slope, the first and second conveyor belts, acting in concert, may direct the object(s) upward, for example, through a space created between the back side of the second conveyor belt (e.g., of the guiding component 20) and the front side of the first conveyor belt (e.g., of the main cleaning component 10), toward a container 50 (e.g., a trash bin positioned at the back of the cleaning device 100).

In some embodiments, the first conveyor belt 11 may include a surface having extrusion and/or recess structure(s), striped or pit structure(s), concave-convex structure(s), wavy concave-convex structure, etc., for more efficiency in guiding the object(s) (e.g., by generating more friction between the conveyor belt's surface and surface of the objects). In some embodiments, the concave-convex structure(s) may include a plurality of equally-spaced distribution of extrusions or recesses, and/or pits and/or convexities.

In some embodiments, the first conveyor belt 11 along a height of the cleaning device may have a sufficiently large surface (e.g., large surface area) to facilitate more efficient moving of the objects (e.g., garbage) from the surface 200 to the container without any air flow (e.g., suctioning or blowing power), for example, generated by a fan or any other airflow unit, hence, reducing the noise, power consumption, and cost associated with the cleaning device 100. In some embodiments, other functional components (e.g., scraper, airflow unit, liquid outlet component, etc.) that are mounted on the cleaning device may facilitate cleaning the surface by the cleaning device.

In some embodiments, the first conveyor belt 11 may include a surface that is made of a first material and the second conveyor belt 211 may include a surface that is made of a second material. In some embodiments, the first material and the second material may be of the same type. In some embodiments, the first material may be less rigid than the second material. In some such embodiments, the second conveyor belt 211 with a higher rigidity, for guiding and transferring objects, may have a longer performance life with respect to the first conveyor belt 11 having the lower rigidity, for providing tight tension against the surface 200. In other embodiments, the first material may be more rigid than the second material.

In some embodiments, the first material may be made of a soft material and/or an absorbing material (e.g., a cleaning fleece) such that the first conveyor belt 11 may be tightly pressed against and clean the surface 200, especially a surface with smudges or liquids. In some embodiments, the second material may be made of a hard material (e.g., plastic, rubber, etc.). In some embodiments, the second material may also be made of a soft material.

In some embodiments, one or both of the conveyor belts may be made of different layers with each layer having a different material. As an example, in some embodiments, each of the conveyor belts may include three layers. In some such embodiments, the outermost layer may be made of a cleaning cloth, a flocking cloth, or a combination of a brush and a cleaning cloth or a flocking cloth. The middle layer may include a mesh cloth substrate in some embodiments while the innermost layer may include a silicone inner ring or rubber. In some other embodiments, the number of layers in each conveyor belt may be different and the material used in each layer may also be different than what is described herewith.

In some embodiments, a distance from an end portion of the guiding component 20 away from the surface 200 to the surface 200 may be greater than or equal to a distance from an end portion of the main cleaning component 10 away from the surface 200 to the surface 200. For example, a height of the guiding component 20 may be greater than a height of the main cleaning component 10. However, the relative positions of the guiding component 20 and the main cleaning component 10 are not limited to the embodiments provided herein.

In some embodiments, the outer diameter of the second plane forming member 213 may be smaller than the outer diameter of the second roller 212. In some other embodiments, the outer diameter of the second plane forming member 213 may also be greater than or equal to the outer diameter of the second roller 212.

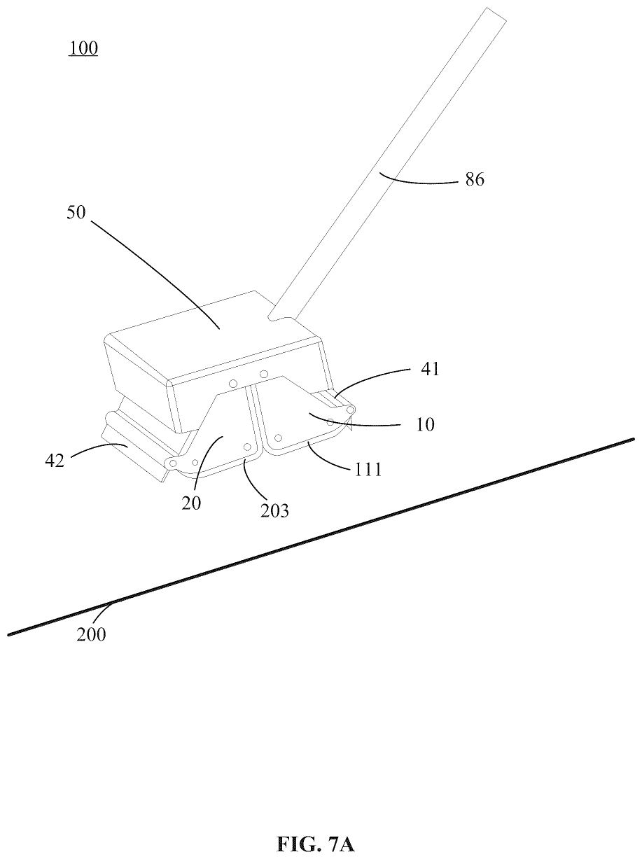

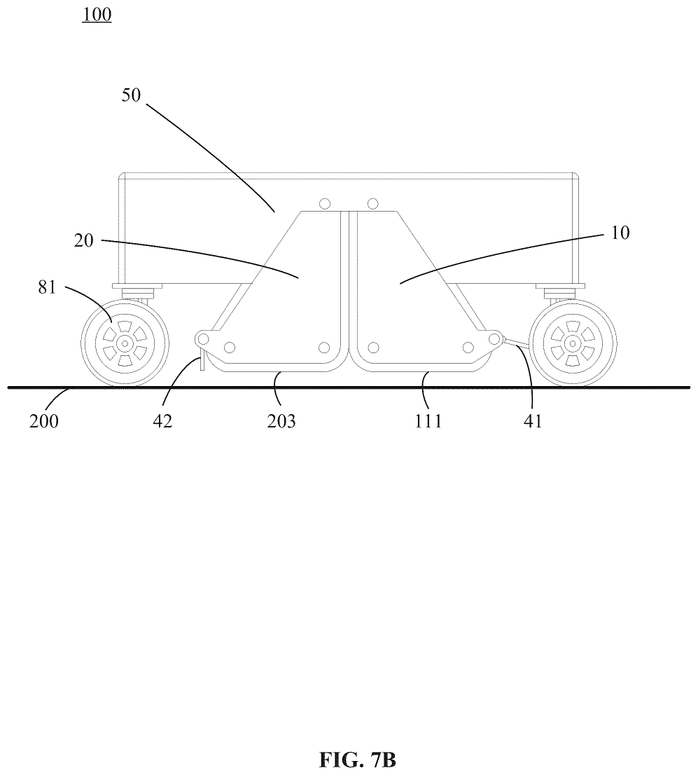

In some embodiments, the oppositely-directed rotations of the first rotatable conveyor belt 11 and the second rotatable conveyor belt 211 may be driven by an external force. The external force may include a driving engine (e.g., a control unit). In some embodiments, a handheld unit that is a manually controlled cleaning apparatus (e.g., a handheld cleaning apparatus such as a broomstick, a mopping stick, etc., may be used for pushing and/or pulling the device across a surface), such as those shown in FIGS. 7A and 7B.

In other embodiments, the second rotatable conveyor belt 211 of the guiding component 20 may wrap and rotate around various combinations and configurations of the at least one second roller 212 and the at least one second plane forming member 213 of the guiding component 20 to form an induction slope 202 that may guide an object on the surface 200 towards the main cleaning component 10 and/or form a plane that may press against and clean (e.g., sweep) the surface 200. Meanwhile, the first rotatable conveyor belt 11 of the main cleaning component 10 may wrap and rotate around various combinations and configurations of the at least one first roller 12 and the at least one first plane forming member 13 of the main cleaning component 10 to form a plane 111, which may press against and clean (e.g., sweep and/or mop) the surface 200. The combination of the oppositely rotating first conveyor belt 11 and second conveyor belt 211 may guide the object through a space between the main cleaning component 10 and the guiding component 20. The number of the at least one second roller 212 and the at least one second plane forming member 213 of the guiding component 20 as well as the number of the at least one first roller 12 and the at least one first plane forming member 13 of the main cleaning component 10 may be one, two, three, or more, and is not limited to the embodiments in the present disclosure.

In some embodiments, the roller(s) (e.g., rollers 12/212) may be positioned laterally with respect to the plane forming member(s) (e.g., 13/213). In some embodiments, the roller(s) may be positioned directly above or below, or diagonally above or below the plane forming member(s). The numbers, shapes, configuration, and relative positions of the roller(s) and the plane forming member(s) are not limited to the embodiments provided herein as long as the guiding component (e.g., 20) may provide an induction slope that may guide (e.g., move) an object on a surface towards the main cleaning component (e.g., 10) while the main cleaning component may provide a plane that may press against and clean (e.g., sweep and/or mop) the surface.

FIGS. 7A and 7B are two diagrams illustrating example embodiments of an external force for moving the cleaning device, in accordance with an example embodiment of the present disclosure. In some embodiments, the external force of the cleaning device 100 may include a handheld unit, as the handheld unit 86 shown in FIG. 7A. In some embodiments, the cleaning device 100 may include a handheld stick (e.g., a pole) 86, a container 50, a main cleaning component 10, and a guiding component 20 (e.g., which may be a second main cleaning component). The container 50, the main cleaning component 10, and the guiding component 20 shown in FIG. 7A may be similar to those described in FIGS. 1-5D, thus detail descriptions will not be redescribed here again for the sake of brevity. In some embodiments, the guiding component 20 in FIG. 7A may include a plane 203 (e.g., similar to the plane of the main cleaning component) that may be pressed against the surface 200 for cleaning (e.g., sweeping objects off the surface towards the space between the main cleaning component 10 and the guiding component 20 and into the container 50). With the plane 203 of the second conveyor belt 211 and the plane 111 of the first conveyor belt 11, object(s) under the cleaning device 100 may be guided towards the space between the guiding component 20 and the main cleaning component 10 more efficiently.

The main cleaning component 10 of FIG. 7A may also include a plane 111 that may be pressed against a surface 200 for cleaning (e.g., mopping liquid or smudges on the surface 200). In some embodiments, the cleaning device 100 may further include a drying component 41 (e.g., a scraper) positioned behind the main cleaning component 10 to clean and/or dry any remaining liquid left on the floor (e.g., liquid generated by the cleaning device 100 itself and/or liquid waste) after the main cleaning component 10 cleans the surface 200. In some embodiments, the cleaning device 100 may also include a second drying component 42 (e.g., a second scraper) to clean and/or dry any remaining liquid left on the floor (e.g., liquid generated by the cleaning device 100 itself and/or liquid waste) after the guiding component 20 (e.g., which in the illustrated example includes a second main cleaning component) cleans the surface 200.

In some embodiments, a cleaning device 100 may include a handheld unit (not shown in FIG. 7B). In some such embodiments, the cleaning device 100 in FIG. 7B may be substantially similar to the cleaning device 100 in FIG. 7A, thus detail descriptions will not be redescribed here again for the sake of brevity. The cleaning device 100 in FIG. 7B may differ from the cleaning device in FIG. 7A in that the cleaning device 100 in FIG. 7B may include a container 50 that is elongated to provide more space for holding the objects (e.g., garbage) and also to accommodate the addition of one or more wheels 81, which may facilitate the mobility of the cleaning device shown in FIG. 7B. In some embodiments, the handheld unit 86 may be used by a user to move the cleaning device 100 forward and/or backward. In some embodiments, when the cleaning device 100 moves forward, the main cleaning component 10 may clean the surface 200 with the help of the guiding component, as described above. Conversely, when the cleaning device 100 moves backward though, the guiding component 20 may act as a second main cleaning device that cleans the surface 200 with the help of the main cleaning component 10, which under this scenario may act as a second guiding component for the second main cleaning component.

As will be described in great detail below, with reference to FIGS. 9A and 9B, in some embodiments, the scrapers 41 and 42, as shown in FIGS. 7A and 7B, may scrape against the surface 200 and may dry/clean the surface (e.g., with the help of an airflow unit that is not shown in these figures) after their corresponding cleaning components clean the surface 200. For example, when the cleaning device 100 moves forward, the scraper 41 may dry/clean the surface 200 after the first main cleaning component 10 cleans the surface. Conversely, when the cleaning device 100 moves backward, the scraper 42 may dry/clean the surface 200 after the second main cleaning component 20 cleans the surface. In some embodiments, as will be described in more detail below, the scrapers 41 and 42 include retractable scrapers. That is, each scraper may be disengaged from scraping the surface when the surface is rough (e.g., when the surface is uneven). Conversely, the scrapers 41 and 42 may be engaged in scraping the surface when the surface is smooth (e.g., when the surface is flat).

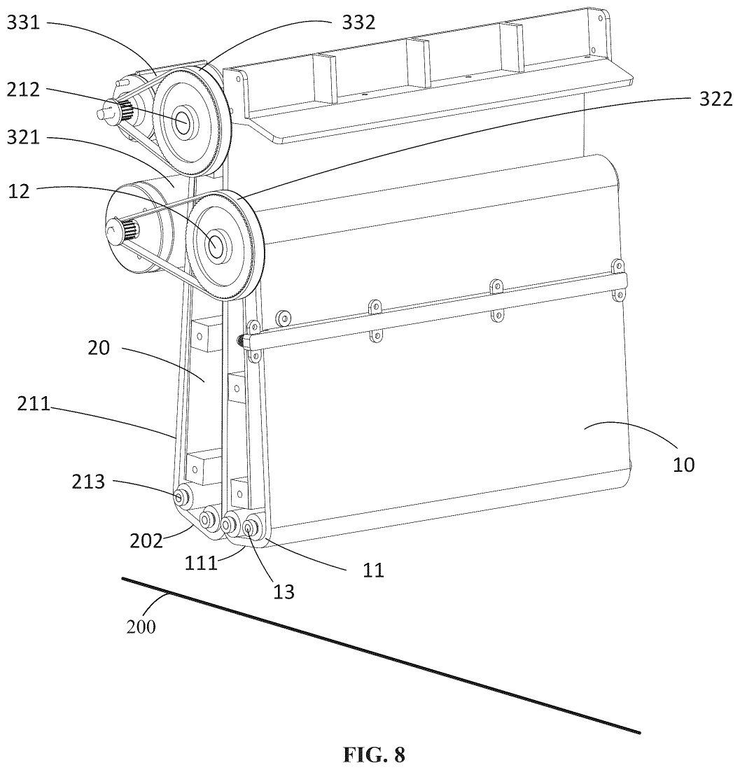

As discussed above, an external force for rotating the conveyor belts of the cleaning device 100 may include a driving engine. FIG. 8 is a diagram illustrating an external force for rotating the conveyor belt(s) of the cleaning device, in accordance with an example embodiment of the present disclosure. In some embodiments, the driving engine may include a control unit 31 (e.g., as shown in FIG. 1B), one or more motors, and one or more transmission belts, all of which may directly or indirectly control the rotations of the first rotatable conveyor belt 11 and the second rotatable conveyor belt 211. In some embodiments, the control unit 31 (e.g., as shown in FIG. 1B) may be electrically coupled to a power supply (e.g., rechargeable battery, an electrical connection to an external power outlet such as AC/DC, solar powered, etc.) and one or more motors, such as motors 331 and 321 (e.g., as shown in FIG. 8). For example, in some embodiments, the second motor 331 may be rotatably connected to a second roller 212 of the guiding component 20 via a transmission belt 332, such that the second motor 331 may drive the rotation of the roller 212, which in turn may rotate the second rotatable conveyor belt 211 in a first direction (e.g., a counterclockwise direction). In some such embodiments, the counterclockwise rotation of the second rotatable conveyor belt 211 may, in addition to cleaning the surface, guide an object placed on the surface 200 towards the main cleaning component 10.

In some embodiments, the control unit 31 (e.g., as shown in FIG. 1B) may also be electrically coupled to a first motor 321 (e.g., as shown in FIG. 8). The first motor 321 may be rotatably connected to a roller 12 of the main cleaning component 10 via a transmission belt 322, such that the first motor 321 may drive the rotation of the roller 12, which in turn may rotate the rotatable conveyor belt 11 in a second direction (e.g., a clockwise direction) opposite the first rotating direction of the rotatable conveyor belt 211. In some such embodiments, the object guided from the counterclockwise rotation of the rotatable conveyor belt 211 may further be moved towards the space between the main cleaning component 10 (e.g., front side 101 of the first conveyor belt 11 in FIG. 2) and the guiding component 20 (e.g., back side 201 of the second conveyor belt 211 in FIG. 2).

In some embodiments, the motors 321, 331 and the transmission belts 322, 332 may be installed within the same enclosure (e.g., housing, frame, bracket, etc.) as the conveyor belts 11, 211. In some embodiments, the motors 321, 331 and the transmission belts 322, 332 may be installed outside of the same enclosure (e.g., housing, frame, bracket, etc.) as the conveyor belts 11, 211. In some embodiments, the transmission belts 322, 332 may be partially installed within the same enclosure (e.g., housing, frame, bracket, etc.) as the conveyor belts 11, 211. In some embodiments, the transmission belts 322, 332 may be replaced by other types of transmission mechanisms, such as gears, chains, etc. Thus, the configurations and types of motors and transmission belts are not limited to the embodiments provided herein. Although not shown in FIG. 8, in some example embodiments, one or more of the motors may be integrated with their corresponding rollers. That is, in some such embodiments, a motor may be inserted within its corresponding roller and as such, no transmission belt (or other transmission mechanisms) may be needed to couple the motor to its corresponding roller.

In some embodiments, the control unit 31 may electrically control a single motor that is rotatably coupled to both the roller 12 of the main cleaning component 10 and the roller 212 of the guiding component 20. In some embodiments, the control unit 31 may control a linear speed of the roller 12 of the main cleaning component 10 and/or the roller 212 of the guiding component 20 (e.g., via motors and transmissions belts). In some embodiments, the linear speed of the roller 12 and the linear speed of the roller 212 may be the same or different. In some such embodiments, configuring different linear speeds between the rollers 12, 212 may facilitate turning less tangible objects (e.g., such as a sheet of paper, hair, or other substantially two-dimensional objects) between the space created between the front side (e.g., 101 in FIG. 2) of the rotating conveyor belt 11 and the back side (e.g., 201 in FIG. 2) of the rotating belt 211 into more tangible objects (e.g., crumbled-up paper, hair ball, or other substantially three-dimensional objects), for example, via rubbing between two oppositely rotating conveyor belts 11 and 211. In some such embodiments, the linear speed of the roller 212 may be higher than the linear speed of the roller 12.

FIGS. 9A and 9B are two diagrams illustrating example embodiments of a drying component of the cleaning device, in accordance with an example embodiment of the present disclosure. In some embodiments, the cleaning device 100 of the present disclosure may include a main frame 82 (e.g., as shown in FIGS. 1B and 9A) and a connecting frame 83 (e.g., as shown in FIGS. 1B, 5C, 5D). The connecting frame 83 may rotatably connect the guiding component 20 to the main cleaning component 10, and may be slidably coupled to the main frame 82. In some embodiments, the connecting frame 83 may be slidably coupled to the main frame 82 in a liftable manner. That is, the connecting frame 83, along with the other components/units coupled to the connecting frame, may be liftably engaged on and/or disengaged from the cleaning device 100 in some embodiments. As such, a user may easily attach and/or detach the cleaning components, such as the main cleaning component and the guiding component, to/from the cleaning device 100.

In some embodiments, the connecting frame 83 may be slidably coupled to the main frame 82 through a guide rail 84 and a sliding member 85. In some embodiments, the sliding member 85 may include several rollers or rotatable bearings (e.g., three bearings as shown in FIG. 1B) mounted on the connecting frame 83 and the guide rail 84 may be tightly coupled between the sliding member 85 (e.g., bearings shown in FIG. 1A), such that the connecting frame 83 may be smoothly lifted up or dropped down with respect to a height of the cleaning device 100. In some embodiments, the guide rail 84 may be an elongated member configured parallel with a height of the cleaning device 100 (e.g., as shown in FIG. 1B) while, in other embodiments, the guide rail 84 may be an elongated member configured at an angle with a vertical direction of the cleaning device 100. In some embodiments, the connecting frame 83, guide rail 84, and the sliding member 85 may be disposed on two sides of the main frame 82 to support rotation and change in elevation of the guiding component 20 with respect to the main cleaning component 10. In some embodiments, a combination of gear(s), bracket(s), rod(s), cable(s) and rack(s) may also provide similar functions as the guide rail 84 and the sliding member 85. With the connecting frame 83, the guide rail 84, and the sliding member 85, the guiding component 20 that is rotatably connected to the connecting frame 83 may be lifted/elevated with respect to the main frame 82 and may be detached from the cleaning device 100. In some embodiments, the guiding component 20 and the connecting frame 83 may be pressed against the main cleaning component 10 due to their combined weight, such that the main cleaning component 10 may press against and clean (e.g., mop) the surface 200.

In some embodiments, the cleaning device 100 may include a drying component 41, as shown in FIGS. 9A and 9B, for removing liquid (e.g., cleaning liquid used for cleaning the surface, waste liquid, liquid mixed with small waste particles, etc.) from the surface 200. A drying component 41, as shown in FIG. 9A, may be positioned (e.g., mounted on the main frame 82) behind the main cleaning component 10 along a moving direction (e.g., direction of the displayed arrow) of the cleaning device 100. The drying component may dry at least one of the surface 200 (e.g., removing liquid from the surface 200) and the main cleaning component 10 (e.g., after the main cleaning component is washed/cleaned, as a result of performing a self-cleaning function). In some embodiments, the drying component 41 may include a scraper 411, a driving unit 412, and one or more airflow units 413, as shown in FIG. 9B.

In some embodiments, the scraper 411 may be controlled (e.g., driven) by the driving unit 412 to, for example, move and/or retract the scraper 411. In some such embodiments, the driving unit 412 may drive the scraper 411 to, for example, only swing about a longitudinal axis of the cleaning device 100 along the scraper 411, swing and lift, only lift, only drop, and/or press against the surface 200. In some embodiments, the driving unit 412 may be an electrically powered, pneumatically powered, or manually powered.

In some embodiments, the driving unit 412 may control the scraper 411 to place the scraper in different positions. For example, the scraper 411 may be positioned to press against the main cleaning component 10 (e.g., for self-cleaning), positioned to press against the surface 200 for cleaning the surface (e.g., sweeping (small) objects, such as dust, solid waste, stains, squeegeeing liquid off the surface, etc.), or positioned to be separated (e.g., lifted) from the surface 200, for example, when cleaning (e.g., sweeping) is not required, or when the surface type is not suitable for scraping. In some embodiments, the driving unit 412 may drive the scraper 411 to move towards the surface 200 when the surface 200 is a certain type of surface, such as a smooth surface and/or a flat surface. In some embodiments, the driving unit 412 may control the scraper 411 to retract and move away from the surface 200 when the surface 200 is another type of surface, such as a rough surface and/or an uneven surface.

In some embodiments, the airflow unit 413 may include at least one air outlet 413 (e.g., as shown in FIG. 9B) for blowing air towards an area on the surface 200 between the main cleaning component 10 and the scraper 411. In some embodiments, two air outlets 413 may be placed near two ends of the scraper 411 and may be oriented towards the area on the surface 200 between the main cleaning component 10 and the scraper 411, such that the air blown from the two air outlets 413 may guide any remaining liquid on the surface 200 toward the front and center of the scraper 411. As such, the scraper 411 may clean off the liquid and prevent any leakage out of the two ends of the scraper 411. In some embodiments, the two air outlets 413 may blow air to the area on the surface 200 that is between the main cleaning component 10 and the scraper 411 and also blow air to the area on the surface 200 behind the scraper 411 (e.g., FIGS. 9B and 9C(F)).

In some embodiments, the airflow unit 413 may blow air toward the scraper 411, the area in front of the scraper 411, and the area behind the scraper 411. In some embodiments, in addition to guiding liquid toward the center of the scraper 411 to prevent leakage at the two end sides of the scraper, the airflow unit 413 may blow air to partially dry the surface 200 and/or the scraper 411. In some embodiments, the airflow unit may dry the surface 200 using the help of an air suction unit, as described in detail below. In some embodiments, the airflow unit 413 may blow air toward the main cleaning component 10 to dry this component, for example, when the cleaning device 100 is in a self-cleaning mode. The liquid on the surface 200 and/or the main cleaning component 10 may include waste liquid, or a mixture of liquid and small particles. In addition to, or in conjunction with, the waste liquid, the liquid on the surface 200 and/or the main cleaning component 10 may include cleaning liquid that the cleaning device 100 uses (e.g., output from a liquid outlet component of the cleaning device, as described below) to clean/wash the surface 200 and/or the main cleaning component 10.

In some embodiments, the airflow unit 413 may include at least one electric heating member configured to generate heat. In some such embodiments, the electric heating member may include at least one of a resistance-type electric heating member, a ceramic-type electric heating member, etc. In some embodiments, the airflow unit 413 may include an infrared heating member for providing heat towards the first conveyor belt 11 and the surface 200.

In some embodiments, the cleaning device 100 of the present disclosure may further include a second drying component (not shown) positioned (e.g., mounted on the main frame 82) in front of the second conveyor belt 211 along the moving direction of the cleaning device 100 (e.g., direction of the displayed arrow). The second drying component may dry at least one of the surface 200 in front of the guiding component (e.g., removing liquid from the surface 200) and the guiding component 20. The second drying component in the present embodiments may include a second scraper, a second driving unit, and a second airflow unit substantially similar to the scraper 411, the driving unit 412, and the airflow unit 413 as shown in FIG. 9B. Thus, detail descriptions of the second scraper, the second driving unit, and the second airflow unit of the second drying component will not be redescribed here again for the sake of brevity. In some embodiments, the second scraper may be positioned to press against the guiding component 20 for self-cleaning, press against the surface 200 for scraping the surface, and be lifted from the surface 200 for when cleaning is not necessary (or the surface is not smooth). In some embodiments, the second driving unit may be an electrically powered, pneumatically powered, or manually powered.

In some embodiments, the second drying component in the present embodiments may differ from the drying component 41 (e.g., FIG. 9B) in that the second airflow unit of the second drying component may blow air towards a space between the second conveyor belt 211 and the second scraper, for example, when the cleaning device 100 moves (or be pushed) backwards (e.g., opposite direction of the displayed arrow in FIG. 9A). In some embodiments, the second air flow unit may also blow air in front of the second scraper when the cleaning device 100 moves backwards.

In some embodiments, when the cleaning device 100 moves in a forward direction (e.g., direction of the displayed arrow in FIG. 9A) for cleaning the surface 200, the driving unit 412 may move the scraper 411 of the drying component 41 towards the surface 200 to press against and remove liquid from the surface 200 while the second driving unit moves the second scraper of the drying component away (e.g., lift) from the surface 200. In some embodiments, when the cleaning device 100 moves backward (e.g., direction opposite the forward direction), the second driving unit moves the second scraper of the second drying component to press against and remove liquid from the surface 200 while the driving unit 412 moves the scraper 411 of the drying component 41 away (e.g., lift) from the surface 200.

As discussed above, an object may be transported (e.g., upward) through a space that is created between two oppositely facing sides of two conveyor belts (e.g., of the main cleaning component and the guiding component) and may eventually be transported to a container positioned at the end of the path of movement of the object (e.g., the container may be positioned at the back, front, or top of the cleaning device).

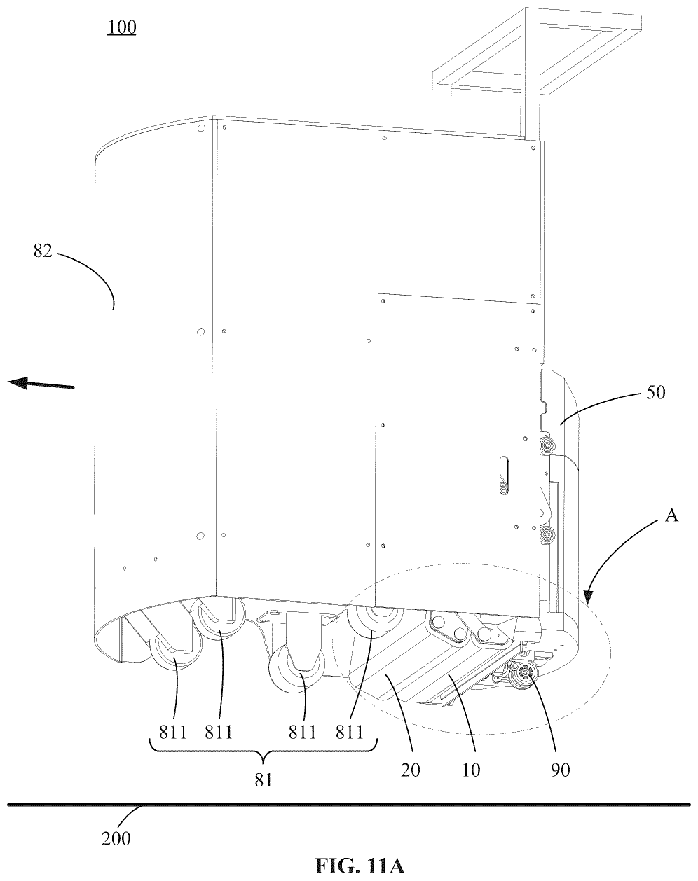

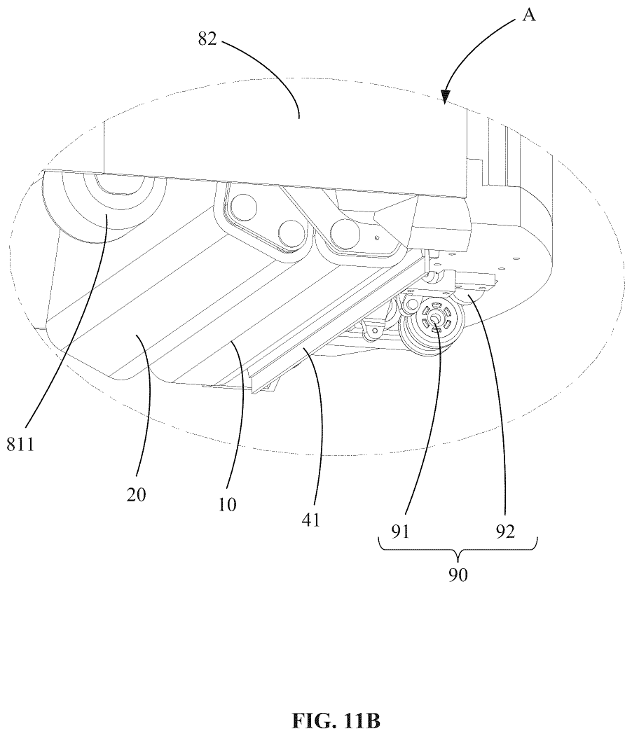

As discussed above, the scraper 411 of the drying component 41 may move forward (e.g., inward) when the self-cleaning function of the cleaning device 100 is activated. In general, the cleaning device of some embodiments may have three different modes of operation. In some embodiments, the first mode of operation of the cleaning device 100 may be for cleaning the surface 200, the second mode of operation may be for when the cleaning device is off, or when the cleaning device is on but not able to clean the surface (e.g., when the surface is uneven, or not flat), and the third mode of operation may be for self-cleaning. It should be noted that the first two modes of operation, in relation with the elevating component, are discussed below with reference to FIGS. 11A-11B.

FIG. 9C is a diagram illustrating different modes of a scraper 411 of the cleaning device 100, in accordance with an example embodiment of the present disclosure. More specifically, FIG. 9C illustrates how the scraper's positions in different modes of the cleaning device 100 may change. As shown in FIG. 9C, when the cleaning device 100 is in the first mode (e.g., cleaning mode of operation), shown as the (F) mode in the figure, the scraper 411 may be configured to move down to scrape against the surface 200, while in the second mode of operation, shown as the(S) mode in the figure, the scraper 411 may be configured by the control unit (e.g., via an elevating component 90, as shown in FIG. 11B, 12A and the related descriptions) to move up and away from the surface 200. In the third mode of operation, shown as the (T) mode in the figure, the scraper 411 may move forward (e.g., toward the conveyor belt 11) to scrape against the conveyor belt 11 and clean it. In this mode of operation, the conveyor belt 11 may scrape small objects (e.g., dust, water, etc.) off the scraper 411 and clean it.

The cleaning device 100 may include a control unit (e.g., such as control unit 31, as shown in FIG. 1B) that is configured to move and/or rotate the scraper 411 in different positions and/or directions as a mode of operation of the cleaning device changes between the first, second, and third modes of operation. The control unit 31 may move the scraper 411 through controlling the driving unit (or driving member) 412, as described above. In some embodiments, the cleaning device 100 may be able to operate in the second and third modes of operation simultaneously. That is, in some embodiments, a user may activate the self-cleaning function of the cleaning device while the device is off, or when the device is not able to clean the surface (e.g., when the surface is rough or not smooth) efficiently. As an example, when the cleaning device 100 is used to clean the surface and to remove liquid from the ground (e.g., in the first mode), if a small object on the ground (e.g., a piece of grain) adheres on the conveyor belt 11 (or the scraper 411), which may affect the cleaning efficiency of the conveyor belt 11 or the liquid removal efficiency of the scraper 411, the user of the cleaning device 100 may activate the self-cleaning function of the cleaning device 100 (e.g., using the user interaction interface 34) to clean the conveyor belt 11 (and/or the scraper 411).

In some embodiments, the one or more airflow units 413 (e.g., as shown in FIG. 9B) may be controlled by the control unit 31 to blow air towards at least one of an area on the surface 200 between the main cleaning component 10 and the scraper 411, toward the main cleaning component 10, and/or toward the scraper 411. In some embodiments, when the cleaning device 100 is in the first mode of operation (e.g., cleaning mode), the control unit may control the conveyor belts of the main cleaning component and the guiding component to rotate in opposite directions to guide an object between the conveyor belts upward and toward the container, and may control the scraper to be pressed against the surface 200, as shown in FIG. 9C(F)) to scrape the surface after the object is removed from the surface. In some embodiments, when the cleaning device 100 is in the first mode of operation (e.g., cleaning mode), the control unit may control the conveyor belts of the main cleaning component and the guiding component to rotate in opposite directions to guide an object between the conveyor belts and toward the container, may control the scraper to be pressed against the surface, and may control the airflow units to blow air toward the surface and dry the surface in order to further improve the cleaning efficiency. In some embodiments, when the cleaning device 100 is in the third mode of operation (e.g., self-cleaning mode, in which the scraper 411 may be pressed against the conveyor belt 11 of the main cleaning component 10, as shown in FIG. 9C, mode (T)), the one or more airflow units 413 may be controlled by the control unit 31 to blow air towards the conveyor belt 11 of the main cleaning component 10 to further improve the cleaning efficiency (e.g., in addition to the scraper 411 pressing against the conveyor belt 11 of the main cleaning component 10).

In some embodiments, as described in more detail below, with reference to FIGS. 11A-B, the cleaning device may automatically switch between the different modes, for example, from the first mode (e.g., cleaning mode) to the second mode (e.g., off mode) and/or the third mode (e.g., self-cleaning mode) or vice versa. For example, when the cleaning device determines that a type of the surface has changed (e.g., from a smooth or even surface to a rough or uneven surface, such as a thick carpet), the cleaning device may automatically switch from the first mode to the second mode and/or the third mode. The cleaning device may make such a determination using one or more sensors and/or detectors that are installed on the cleaning device. As another example, the cleaning device may automatically switch from the third mode (e.g., self-cleaning mode) to the first mode (e.g., cleaning mode), for example, when the cleaning device determines (e.g., using its one or more sensors and/or surface type detection units) that a type of surface has changed (e.g., from an uneven surface to a smooth or even surface). In some embodiments, automatic switching among the three modes, as described above, may be independent of the cleaning device's determination of a change in the type of the surface and may not be limited to the example embodiments provided herein.

In addition to, or instead of, the automatic switching between the different modes, a user may be able to change the different operational modes of the cleaning device 100, for example, using the user interaction interface/component 34 (e.g., and the control unit 31), as shown in FIG. 1B. Additionally, in some embodiments, the user may be able to adjust the distance between the scraper 411 and the surface 200 (e.g., when the cleaning device 100 is in the first or second mode of operations) and also to adjust the distance between the scraper 411 and the main cleaning component 10 (e.g., when the cleaning device is in the third mode of operation) to clean the surface and/or the conveyor belt 11 more efficiently. In some embodiments, the cleaning device 100 may automatically adjust the distance between the scraper 411 and the surface 200, or the distance between the scraper 411 and the main cleaning component 10, to make the process of cleaning (e.g., the surface 200 and/or the conveyor belt 11) more efficiently.

In some embodiments, the cleaning device 100 may direct cleaning liquid (e.g., water, detergent, etc.) toward the main cleaning component 10 and the surface 200 using the liquid outlet component 71. In some such embodiments, the cleaning device may automatically use the liquid outlet component 71 to pour the cleaning liquid (e.g., water, a disinfectant, a sanitizer, etc.) on the main cleaning component 10 and/or the surface 200 when the device is in the self-cleaning mode. In some embodiments, a user may be able to activate the liquid outlet component 71, for example, using the user interaction component 34 (e.g., and the control unit 31).

In some embodiments, the cleaning device 100 may use the driving unit 412 of the drying component 41 to adjust a distance between the scraper 411 (e.g., when switching between the first and second modes of operation) and the surface 200 and/or to rotate the scraper 411 (e.g., when switching between the first and third modes of operation). In some embodiments, the scraper 411 may rise first and then rotate, or may rotate first and then rise. For example, in some embodiments, after the scraper 411 rises to a preset position, the scraper 411 may be driven to rotate toward the main cleaning component 10. In some embodiments, the scraper 411 may perform both rising and rotating actions simultaneously. In some embodiments, the scraper 411 may also rotate backward (e.g., outward) and away from the main cleaning component 10.

In some embodiments, the drying component 41 may further include at least one airflow unit 413 that is positioned near at least one end side of the scraper 411. The at least one airflow unit, in some such embodiments, may blow air (e.g., hot air) toward the surface and dry the surface 200 when the cleaning device is in the first operation mode (e.g., cleaning mode) and blow air toward the main cleaning component 10 (e.g., toward the conveyor belt 11) when the cleaning device is in the third mode of operation (e.g., in the self-cleaning mode). In some embodiments, the at least one airflow unit may blow air (e.g., hot air) toward both the surface 200 and the main cleaning component 10 when the cleaning device is in the first mode and/or the second mode, to dry the surface and the main cleaning component. In some embodiments, the at least one airflow unit includes first and second airflow units 413 that are positioned near two end sides of the scraper 411 (e.g., between the main cleaning component 10 and the scraper 411).

FIG. 10 is a diagram illustrating other components, such as different configurations of a container, a baffle component, and a liquid outlet component, of the cleaning device, in accordance with an example embodiment of the present disclosure. In some embodiments, the cleaning device 100 of the present disclosure may include a container 50 and a baffle component 60 (e.g., consisting of bezels 611, 612, and 62). The baffle component 60 (e.g., as shown in FIG. 10) may be positioned between the container 50 and the main cleaning component 10, to guide an object (e.g., garbage) towards the container 50. In some embodiments, an optional airflow unit (e.g., a fan) may be positioned above the main cleaning component 10 and the guiding component 20. In some embodiments, the fan may form a negative pressure within the container 50. In some embodiments, the fan is positioned in or external to the container 50.

In some embodiments, the container 50 may include a first chamber 51 and a second chamber 52. In some embodiments, the first chamber 51 may be positioned above the second chamber 52, as shown in FIG. 10. In some embodiments, the baffle component 60 (e.g., as shown in FIG. 10) may include a first bezel 611 for scraping a first type of objects (e.g., solid waste) off the first conveyor belt 11 and guiding the first type of objects toward the chamber 51. In some embodiments, the baffle component 60 (e.g., as shown in FIG. 10) may also include a second bezel 612 for scraping a second type of objects (e.g., liquid waste) off the first conveyor belt 11 and guiding the second type of objects toward the chamber 52. In some embodiments, the first and second bezels 611 and 612 may include a board, a plate, etc. The first and second bezels 611 and 612 may be positioned behind the first conveyor belt 11 and may extend from a back side of the first conveyor belt 11 toward the container 50 (e.g., toward the first chamber 51 and the second chamber 52, respectively). In some embodiments, the baffle component 60 may only include one bezel (e.g., bezel 611) associated with the main cleaning component and a second bezel 62 (as described in more detail below) associated with the guiding component.

In some embodiments, a gap may be predetermined between the first and second bezels 611, 612 and the first conveyor belt 11, such that rotations of the first conveyor belt is not affected. In some embodiments, the first bezel 611 may be positioned above the second bezel 612. In some embodiments, the first and second bezels 611, 612 may each be a slanted plate that are extending, respectively, from the back side of the first conveyor belt 11 toward the first chamber 51 and the second chamber 52 of the container 50.

Based on the embodiments described above, objects of, for example, two different sizes coming from the space formed between the main cleaning component 10 and the guiding component 20 may be correspondingly separated by their sizes and be correspondingly guided into the first chamber 51 and the second chamber 52. In some embodiments, an object having a large size that is coming off from the space between the main cleaning component 10 and the guiding component 20 may be separated and guided towards the first chamber 51 via the first bezel 611 while an object having a smaller size that is coming off from the space between the main cleaning component 10 and the guiding component 20 may be separated and guided towards the second chamber 52 via the second bezel 612.

In some embodiments, smaller sized objects may also be guided towards the first chamber 51 and larger sized objects may also be guided towards the second chamber 52. In some embodiments, for example, when the baffle component 60 has only one bezel associated with the main cleaning device (e.g., bezel 611), all types of objects are guided toward the first chamber 51. In some embodiments, a separator, such as a filtering screen, may separate the first and second chambers. In some such embodiments, the filtering screen (not shown in the figure) may let the smaller size objects to pass through to the second chamber 52 when the smaller size objects are initially moved to the first chamber 51. In some embodiments, a space between the first bezel 611 and the back side of the conveyor belt 11 may be greater than a space between the second bezel 612 and the back side of the conveyor belt 11. Such a configuration may allow the bigger size objects to be scraped off the conveyor belt 10 and guided to the first chamber 51, while the smaller size objects may be scraped off the conveyor belt 10 and guided to the second chamber 52. In some embodiments, the first chamber 51 may be designated to store solid-type objects (e.g., solid waste, etc.) while the second chamber 52 may be designated to store liquid-type objects (e.g., liquid waste, etc.).

In some embodiments, the first and second chambers 51 and 52 may be integrally formed as one component. In some embodiments, the number, shape, object-type designation, and positioning of the chambers (e.g., 51, 52) and bezels (e.g., 611, 612) relative to the main cleaning component 10 may be different from the embodiments provided above and should not be limited to the embodiments described above as long as objects coming off the space created between the main cleaning component 10 and the guiding component 20 are efficiently guided towards the container 50 via the first bezel 611 or the second bezel 612.

In some embodiments, not all objects coming off the space between the main cleaning component 10 and the guiding component 20 may be scraped and guided towards the container 50. For example, some objects may be stuck on to the second conveyor belt 211 of the guiding component 20. In some such embodiments, the baffle component 60 may further include another bezel (e.g., a third bezel) 62 for scraping object(s) off the second conveyor belt 211 and guiding the objects from the second conveyor belt 211 toward the main cleaning component 10 and/or the container 50. In some embodiments, the third bezel 62 may be positioned behind the second conveyor belt 211 along the moving direction (e.g., direction of the displayed arrow in FIG. 9A) of the cleaning device 100 and positioned near a top portion of the second conveyor belt 211.

Based on some of the embodiments described above, a combination of the conveyor belts and the baffle component 60, the object(s) on the surface 200 may be swept away and directed to the container 50 without the help of any air blowing/suctioning power, which may provide effective cleaning while reducing noise, time, and cost.

In some embodiments, the cleaning device 100 of the present disclosure may also include a liquid outlet component 71 (e.g., as shown in FIG. 10) to direct liquid towards at least one of the first conveyor belt 11, the second conveyor belt 211, and the surface 200 for cleaning at least one of the first conveyor belt 11, the second conveyor belt 211, and the surface 200. In some embodiments, the liquid outlet component 71 may include a bar having one or several holes in it to output the cleaning liquid toward at least one of the first conveyor belt 11, the second conveyor belt 211, and the surface 200. In some embodiments, the liquid outlet component 71 may include a nozzle, spray head, etc. In some embodiments, the liquid outlet component 71 may be mounted on the main cleaning component 10 (e.g., as shown in FIGS. 9A and 10) or may be positioned anywhere else in the cleaning device 100 (e.g., the main frame 82). In some embodiments, the liquid may be any cleaning liquid/fluid, such as a cleaning fluid, a disinfectant gel, an anti-bacterial fluid, a surface protection liquid, a sanitizer, a gear/part maintenance fluid, water, detergent, liquid wax, surface-care solution, of a combination of one or more of these items, or the like, for cleaning, disinfecting, and/or maintenance.

In some embodiments, the liquid outlet component 71 may dispense/discharge a cleaning liquid/fluid towards the bottom portion of the first conveyor belt 11 such that the main cleaning component 10 may mop and sweep the surface 200. In some embodiments, the liquid outlet component 71 may dispense a cleaning and surface-care fluid towards the bottom portion of the first conveyor belt 11 and the second conveyor belt 211 such that the main cleaning component 10 and the guiding component 20 may press and/or rub the belts 11, 211 against the surface 200, thus disinfecting and/or providing surface care to the surface 200.

In some embodiments, the cleaning device 100 may include a storage container 72 (e.g., as shown in FIG. 1B) for storing the cleaning liquid(s) that supplies to the liquid outlet component 71. In some embodiments, the storage container may be mounted on the main frame 82 (e.g., as shown in FIG. 1B). In some embodiments, the cleaning device 100 may supply the liquid(s) to the liquid outlet component 71 by means of an external source (e.g., external cleaning/disinfecting/maintenance supply storage).

In some embodiments, the number and/or configurations of the container 50 and/or the liquid outlet component 71 may be different from the number and configuration, as shown in FIG. 10. For example, the cleaning device 100 may include two (or more) containers that are positioned in different places (e.g., both in the back as well as in the front side) of the cleaning device. For example, in addition to the first container 50 that is positioned behind the main cleaning component 10 along the moving direction of the cleaning device, in some embodiments, a second container may be positioned in front of the guiding component 20 along the moving direction of the cleaning device. Additionally, the second container may include two or more chambers, such as the chambers 51 and 52 (e.g., instead of, or in addition to, the container 50 having two separate chambers). Under such a configuration (having one container in the back and another container in the front of the cleaning device, where the front container has two chambers), the baffle component 60 may include a bezel 611 which is associated with the back container (e.g., container 50), and two other bezels that are associated with the front container (e.g., each of the two bezels being associated with one of the chambers of the front container).

Also, instead of having one liquid outlet component 71, the cleaning device 100 may include two (or more) liquid outlets (or liquid outlet components) that may be positioned near each other or at different places in the cleaning device. For example, the cleaning device 100 may include a first liquid outlet component 71 that is positioned behind the main cleaning component 10 and a second liquid outlet component that may be positioned in front of the guiding component 20, along a direction of movement of the cleaning device.

In some embodiments, the second liquid outlet component may be configured to output cleaning fluid (or liquid) towards the guiding component 20. As a result, the guiding component 20 may make the surface 200 wet before the main cleaning component 10 cleans (e.g., mops) the surface 200 (e.g., instead of, or in addition to, the guiding component 20 mopping the surface), which may result in a better cleaning effect. As an alternative embodiment, it is also possible for the second liquid outlet component to output cleaning liquid towards the surface 200 itself, or to output cleaning liquid towards both the guiding component 20 and the surface 200.

In some embodiments, the second liquid outlet component may be arranged in front of the guiding component 20 and beneath a bezel that is associated with the guiding component 20 for outputting cleaning liquid towards at least one of the guiding component 20 and the surface 200. This way, after the garbage carried by the guiding component 20 is scraped and guided by the bezel toward the container (e.g., a front container, as described above), the second liquid outlet component may output the cleaning liquid to the guiding component 20 to avoid outputting cleaning liquid onto any potential garbage that is adhered onto the second conveyor belt 211 (e.g., to avoid a waste of cleaning liquid).

In some embodiments, similar to the first liquid outlet component 71, the second liquid outlet component may be in a shape of a strip or bar that has a plurality of holes that are configured to output the cleaning liquid towards the guiding component 20. In some embodiments, the plurality of holes may be uniformly distributed at equal intervals on the first and/or second liquid outlet components. As a result, the cleaning liquid may be uniformly sprayed onto the guiding component 20 (or the main cleaning component 10) through the holes.

In some embodiments, the cleaning device 100 may also include a driving component that may include one or more wheels and one or more motors. FIGS. 11A and 11B are two diagrams illustrating example embodiments of a driving component of the cleaning device, in accordance with an example embodiment of the present disclosure. The driving component may include one or more wheels 81 that may be disposed at the bottom of the cleaning device 100 to provide mobility to the cleaning device 100 (e.g., as shown in FIG. 11A). In some embodiments, the plurality of wheels 81 may be mounted near a bottom portion of the main frame 82 (e.g., as shown in FIG. 1B) to provide mobility to the cleaning device 100. In some embodiments, the plurality of wheels 81 may include four wheels 811. The four wheels 811 may be configured in two rows and two wheels per row (e.g., as shown in FIG. 11A).

It should be noted that the number and configuration of the wheels 811 may be different and are not limited only to the embodiments provided herein. In some embodiments, the cleaning device 100 may include a control unit 31 (e.g., as shown in FIG. 1B) that controls the rotation of the wheels 811 (e.g., by controlling the rotation of one or more motors of the driving component, which in turn may rotate the wheels of the driving component) for controlling the movements of the cleaning device 100. In some embodiments, the same or a different control unit may control the rotations of the first and second conveyor belts 11 and 211.

In some embodiments, the wheels 811 may enable the cleaning device to act as an automatic guided vehicle (e.g., AGV) so that the cleaning device 100 may clean and move about the surface 200 via self-navigated movements and without the need for human interaction. In some embodiments, the cleaning device 100 may not include the wheels 81. In some such embodiments, the cleaning device 100 may be directly applied on and manually moved (e.g., human hand applying a force to the cleaning device 100) over the surface 200 for cleaning while the first conveyor belt 11 and the second conveyor belt 211 may provide mobility to the cleaning device 100 across the surface 200 (e.g., as shown in FIG. 7A).

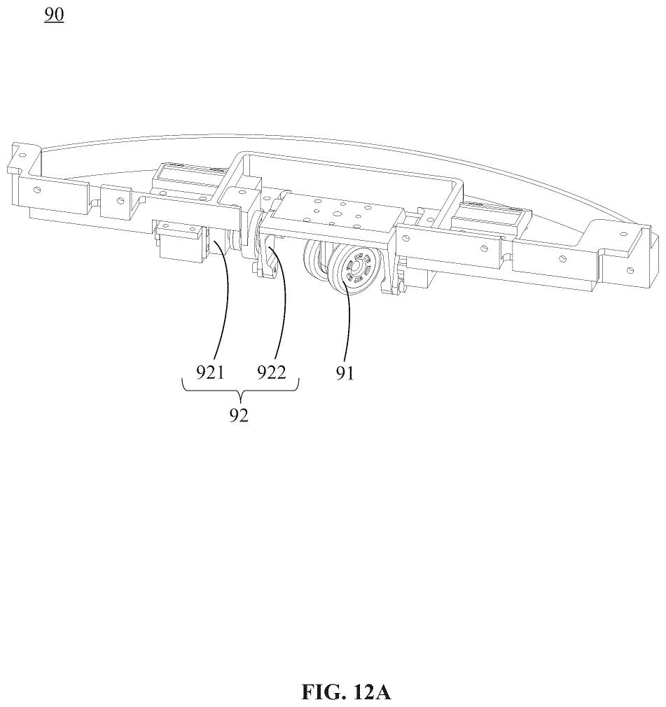

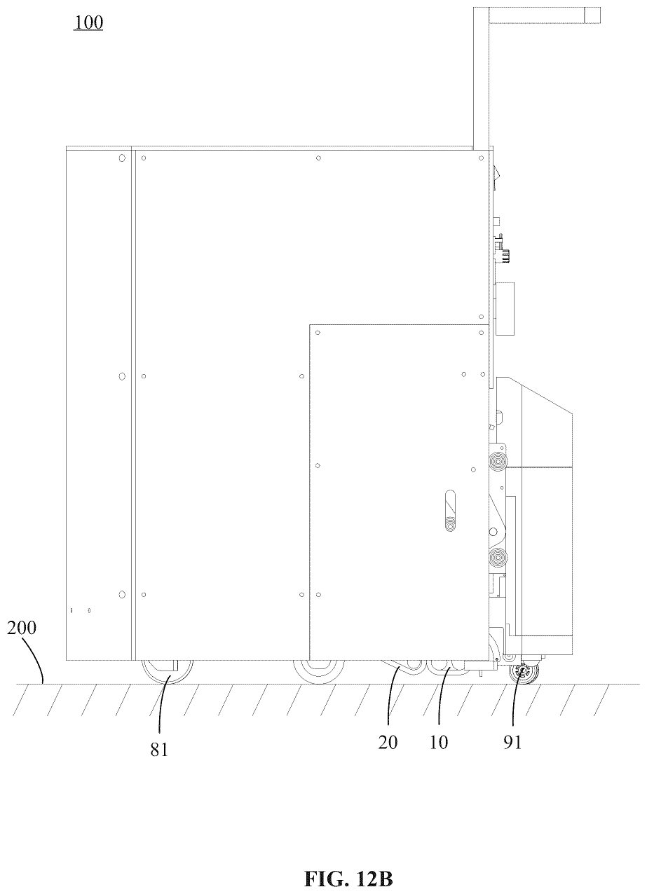

In some embodiments, the cleaning device of the present disclosure may include an elevating component to lift or drop the main cleaning component (and the guiding component). FIGS. 12A and 12B are two diagrams illustrating example embodiments of an elevating component of the cleaning device, in accordance with an example embodiment of the present disclosure. In some embodiments, the cleaning device 100 of the present disclosure may include an elevating component 90 (e.g., as shown in FIGS. 11B, 12A, and 12B) configured to move the main cleaning and guiding components 10 and 20 toward the surface to press against the surface, or away from the surface 200 to create a space between the main cleaning and guiding components 10 and 20 and the surface 200.

In some embodiments, the elevating component 90 may be a bracket or a frame positioned at a bottom of the cleaning device 100 (e.g., as shown in FIGS. 11B and 12A). In some such embodiments, the elevating component 90 may be positioned behind the main cleaning component 10 along the moving direction (e.g., direction of the displayed arrow in FIG. 9A) of the cleaning device 100. In some such embodiments, the elevating component 90 may include an auxiliary support member 91 (e.g., one or more wheels) coupled to the body of the elevating component 90 and a driving member 92 that is coupled to the auxiliary support member 91 (e.g., as shown in FIG. 12A). In some embodiments, the driving member 92 may include a motor 921 and a connecting member 922 (e.g., a swing arm or hinge) physically coupled to the auxiliary support member 91.

In some embodiments, the control unit 31 (e.g., as shown in FIG. 1B) may be electrically coupled to the motor 921, such that after the control unit 31 issues a release command, the connecting member 922 physically connected to the motor 921 may release the auxiliary support member 91 (e.g., outward of the cleaning device 100 and toward the surface 200) to create a space between the main components (e.g., the main cleaning component and the guiding component) and the surface. In some such embodiments, the control unit 31 may issue a retract command, such that the connecting member 922 may retract the auxiliary support member 91 (e.g., inward of the cleaning device 100) to remove the space between the main components (e.g., the main cleaning component and the guiding component) and the surface. In some embodiments, the auxiliary support member 91 may include at least one roller or at least one wheel (e.g., as shown in FIG. 12A).

In some embodiments, the connecting member 922 may also be rotatably connected to the guiding component 20 and the main cleaning component 10. In some such embodiments, the elevating component 90 may lift the connecting frame 83 such that the main cleaning component 10 and the guiding component 20 are lifted (or separated) from the surface 200.

In some embodiments, the cleaning device 100 of the present disclosure may be configured with different modes of operations associated with the various elements of the cleaning device 100. For example, in some embodiments, as discussed above with reference to FIG. 9C, the cleaning device 100 may include three modes of operations, a first mode, a second mode, and a third mode of operation. The third mode of operation (e.g., the self-cleaning mode) of the cleaning device has been discussed above, with reference to FIG. 9C. As such, more detail about the first two modes of operation with relation to the elevating component 90 is described here. In some embodiments, the first (operational) mode (e.g., or a cleaning mode) of the cleaning device 100 may configure the auxiliary support member 91 to be in a retracted state such that the auxiliary support member 91 is lifted away and separated from the surface 200 while the main cleaning component 10 is released and pressed against the surface 200 for cleaning the surface. In some embodiments, such retraction of the auxiliary support member 91 and release of the main cleaning component 10 may be achieved by the physical connection of the connecting member 922 of the elevating component 90 between the auxiliary support member 91 and the main cleaning component 10, as discussed above.

In some embodiments, the second (operational) mode (e.g., non-cleaning mode), or the third (operational) mode (e.g., self-cleaning mode) of the cleaning device 100 may configure the auxiliary support member 91 to be in a released state such that the auxiliary support member 91 is in contact with the surface 200 while the main cleaning component 10 is lifted away and separated from the surface 200 (e.g., as shown in FIG. 12B). In some embodiments, while in the second mode, the cleaning device may stop rotating the conveyor belt 11 (and the conveyor belt 211) when cleaning is not required. In some embodiments, during the first mode (e.g., cleaning mode), the guiding component 20 may be configured to press against the surface 200 for cleaning. In some embodiments, during the second mode (e.g., non-cleaning mode), the guiding component 20 may also be lifted away and be separated from the surface 200.

In some embodiments, such retraction of the auxiliary support member 91 and release of the main cleaning component 10 and/or guiding component 20 may be achieved by the physical connection of the connecting member 922 of the elevating component 90 between the auxiliary support member 91 and the main cleaning component 10 and/or the guiding component 20, as discussed above.

In some embodiments, when the cleaning device 100 moves forward (e.g., direction of the displayed arrow in FIG. 9A) during the second mode (e.g., the main cleaning component 10 and the guiding component 20 configured to be lifted away or separated from the surface 200 while the auxiliary support member 91 is pressed against the surface 200), the main cleaning component 10 and the guiding component 20 may be in a retracted state to prevent unnecessary contact with the surface 200, which may reduce the product life of the main cleaning component 10 and the guiding component 20. In some embodiments, during the first mode (e.g., cleaning mode), the conveyor belt 11 of the main cleaning component 10 and the conveyor belt 211 of the guiding component 20 may rotate in opposite directions for guiding object(s) upward through the space created between the belts 11, 211. In some embodiments, during the first mode, the driving units may drive the scrapers (e.g., in front of the guiding component 20 and/or behind the main cleaning component 10) to scrape against the surface 200. In some embodiments, during the first mode, the airflow units may blow air towards an area between the main cleaning component 10 and the scraper 411, behind the scraper 411, an area on the surface 200 between a scraper (e.g., positioned behind the guiding component 20) and the guiding component 20, and behind such scraper. In some embodiments, during the first mode, the liquid outlet component 71 may direct (e.g., dispense/discharge) liquid (e.g., cleaning/disinfecting/maintaining liquids) towards the first conveyor belt 11, the second conveyor belt 211, and/or the surface 200.

In some embodiments, during the second mode (e.g., non-cleaning mode), the conveyor belt 11 of the main cleaning component 10 and the conveyor belt 211 of the guiding component 20 may stop rotating. In some embodiments, during the second mode, the driving unit 412 may lift the scraper 411 (e.g., in front of the guiding component 20 and/or behind the main cleaning component 10) from pressing against the surface 200. In some embodiments, during the second mode, the airflow units may stop blowing air towards an area between the main cleaning component 10 and the scraper 411, behind the scraper 411, an area on the surface 200 between a scraper (e.g., positioned behind the guiding component 20) and the guiding component 20, and behind such scraper. In some embodiments, during the second mode, the liquid outlet component 71 may stop dispensing/discharging liquid towards the first conveyor belt 11, the second conveyor belt 211, and/or the surface 200.

In some embodiments of the present disclosure, the second mode may also be a cleaning mode while the first mode may also be a non-cleaning mode, thus, the modes of operations are not limited to the embodiments provided above.

In some embodiments, the cleaning device 100 of the present disclosure may include a user interaction interface 34 (e.g., as shown in FIG. 1B). The user interaction interface 34 may be electrically coupled to the control unit 31 (e.g., including a power supply as discussed above) to power on and power off the cleaning device 100. The user interaction interface 34 may also control the cleaning device 100 through the control unit 31 to perform movements and switching between first and second modes of the cleaning device 100, as well as cleaning, sweeping, mopping, and drying of the surface 200, as described above. In some embodiments, the user interaction interface 34 may include at least one of a display screen, a control panel, buttons, knobs, and levers for controlling the operating modes/operations/functions of the cleaning device 100. In some such embodiments, the display may be a screen with a display function or a screen having both a display function and a touch function. In some embodiments, the user interaction interface 34 may include other components that may control the cleaning device 100, but are not limited to the embodiments provided herein.

In some embodiments, a user may switch the cleaning device 100 between the first and second modes using the user interaction interface 34. For example, a user may select the first mode on the user interaction interface 34 (e.g., by touching a specific option displayed on a display screen of the user interaction interface 34, by selecting/hitting a specific button, etc.), and the second mode or a third mode (e.g., self-cleaning mode). In some embodiments, switching between the different modes, instead of, or in conjunction with, using a hand/figure gesture on the user interaction interface 34, may be done through a voice command (e.g., using a voice recognition device included in the user interaction interface 34). In some embodiments, the switching between the three modes may be achieved remotely. For example, a user may furthermore use an electronic device, such as a laptop, a mobile phone, a tablet, etc., that is remotely coupled to the cleaning device 100 (e.g., through one or more networks) to switch the cleaning device 100 between the first, second, and third modes.

In some embodiments, the cleaning device 100 may automatically (e.g., using one or more sensors mounted on the cleaning device) switch between the first mode, the second mode, and the third mode. For example, when a control unit 31 of the cleaning device 100 determines that the surface that has to be cleaned is a certain/first type of surface, such as a smooth surface and/or a flat surface (e.g., after one or more sensors of the cleaning device 100 send a signal to the control unit 31 to make such a determination) the control unit 31 may automatically switch the state of the cleaning device 100 to the first mode (e.g., in which the main cleaning component 10 and the guiding component 20 may be pressed against the surface 200 to clean the surface). In some embodiments, the control unit 31 may determine that the surface 200 that is to be cleaned is a second type of surface, such as a rough surface and/or an uneven surface (e.g., after receiving a corresponding signal from the sensor(s)), the control unit 31 may automatically switch the mode of the cleaning device 100 to the second mode (e.g., in which the main cleaning component 10 and the guiding component 20 are separated from the surface 200).

In some embodiments, the cleaning device 100 may include a power supply (not shown) to supply power to all elements of the cleaning device 100 described in the present disclosure, such as the rollers, plane forming members, and conveyor belt of the main cleaning component 10, as well as the rollers, plane forming members, and conveyor belt of the guiding component 20, motors, wheels, air blowing unit, scrapers, liquid outlet component, control unit, user interaction interface, etc. Such a power supply may include alternating current (AC) power supplies, such as an electrical outlet (wall plugs), etc., and/or direct current (DC) power supplies, such as, rechargeable battery(ies), solar battery(ies), etc.

In some embodiments, the guiding component 20 and the main cleaning component 10 may be separate modules and be installed in or removed from the cleaning device 100 such that the guiding component 20 and the main cleaning component 10 may be separately maintained or serviced.

In some embodiments of the present disclosure, the functions, operation modes, or methods described with reference to FIGS. 1A-12B may be implemented by one or more controllers, such as the control unit 31, and the user interaction interface 34, as depicted in FIG. 1B.

Many of the above-described features and applications, such as switching between the first and second modes, controlling the rotations of the conveyor belts and/or rollers, controlling the liquid outlet component, controlling the elevating component, controlling the drying component, etc., may be implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this disclosure, the term “software” may be meant to include firmware residing in read-only memory or applications stored in magnetic storage, which may be read into memory for processing by a processor. Also, in some embodiments, multiple software may be implemented as sub-parts of a larger program while remaining distinct software. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

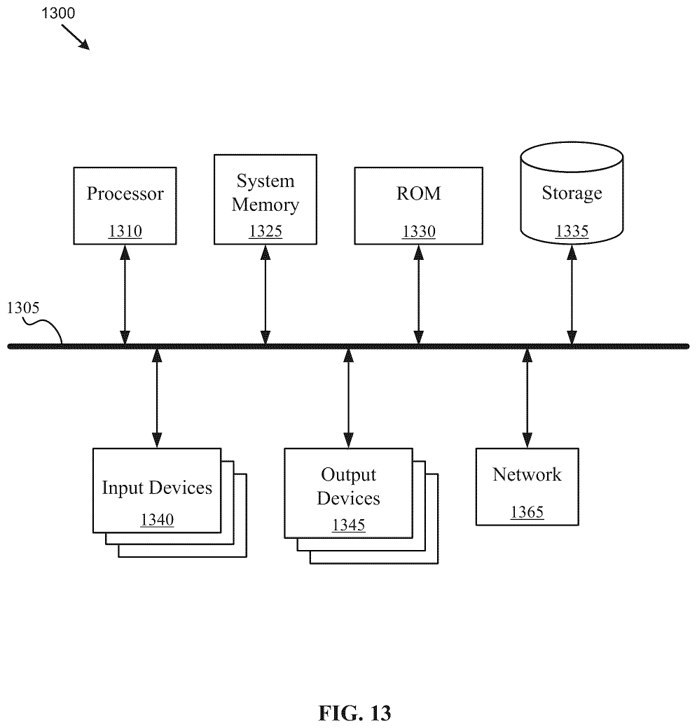

FIG. 13 is a block diagram illustrating an electronic system 1300 of the control unit 31 and/or the user interaction interface 34 of the cleaning device 100, according to one example embodiment of the present disclosure. As shown in FIG. 13, the electronic system 1300 may include a memory (e.g., system memory 1325 and ROM 1330) for storing instructions (e.g., a program or method for controlling the cleaning device 100 to clean/mop/sweep as well as specific instructions to control the rotation and/or rotational speed of the rollers 12, 212, motions of the scrapers, driving unit, elevating component, motors, etc.), a processor 1310 for executing instructions that are stored in the memory to perform the functions and operation modes (e.g., first and second modes, as described above) of the cleaning device 100. The electronic system 1300 may be a computer (e.g., a desktop computer, personal computer, tablet computer, etc.), server, dedicated switch, phone, PDA, or any other sort of electronic or computing device. Such an electronic system may include various types of computer readable media and interfaces for various other types of computer readable media. The electronic system 1300 may include a bus 1305, processing unit(s) 1310, a system memory 1325, a read-only memory 1330, a permanent storage device 1335, input devices 1340, and output devices 1345.

The bus 1305 collectively represents all system, peripheral, and chipset buses that communicatively connect the numerous internal devices of the electronic system 1300. For instance, the bus 1305 communicatively connects the processing unit(s) 1310 with the read-only memory 1330, the system memory 1325, and the permanent storage device 1335.

From these various memory units, the processing unit(s) 1310 retrieves instructions to execute and data to process in order to execute the processes of the present disclosure. The processing unit(s) may be a single processor or a multi-core processor in different embodiments.

The read-only-memory (ROM) 1330 stores static data and instructions that are needed by the processing unit(s) 1310 and other modules of the electronic system. The permanent storage device 1335, on the other hand, is a read-and-write memory device. This device is a non-volatile memory unit that stores instructions and data even when the electronic system 1300 is off. Some embodiments of the present disclosure use a mass-storage device (such as a magnetic or optical disk and its corresponding disk drive) as the permanent storage device 1335.

Other embodiments use a removable storage device (such as a floppy disk, flash memory device, etc., and its corresponding drive) as the permanent storage device. Like the permanent storage device 1335, the system memory 1325 is a read-and-write memory device. However, unlike storage device 1335, the system memory 1325 is a volatile read-and-write memory, such a random access memory. The system memory 1325 stores some of the instructions and data that the processor needs at runtime. In some embodiments, the present disclosure's processes are stored in the system memory 1325, the permanent storage device 1335, and/or the read-only memory 1330. From these various memory units, the processing unit(s) 1310 retrieves instructions to execute and data to process in order to execute the processes of some embodiments.

The bus 1305 also connects to the input and output devices 1340 and 1345. The input devices 1340 enable the user to communicate information and select commands to the electronic system. The input devices 1340 include alphanumeric keyboards and pointing devices (also called “cursor control devices”), cameras (e.g., webcams), microphones or similar devices for receiving voice commands, etc. The output devices 1345 display images generated by the electronic system or otherwise output data. The output devices 1345 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 13, bus 1305 also couples electronic system 1300 to a network 1365 through a network adapter (not shown). In this manner, the computer can be a part of a network of computers (such as a local area network (“LAN”), a wide area network (“WAN”), or an Intranet, or a network of networks, such as the Internet. Any or all components of electronic system 1300 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD−RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this disclosure and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

In some embodiments, the cleaning device 100 may be a commercially available cleaning device or equipment for completely and continuously performing large-area (e.g., especially in public places) cleaning for a sustained period of time. Commercial cleaning equipment may be used for cleaning at least a surface (e.g., floor, ground, walls, glasses, carpets, etc.) of an office building, a bus/train station, a hospital, a shopping mall, a playground, an exterior wall of a high-rise building, a glass window of the high-rise building, etc. In some embodiments, the cleaning device 100 may also be a household cleaning device or equipment mainly used for cleaning small object(s) in small areas, such as an interior surface (e.g., floor, ground, walls, glasses, carpets, etc.) of a residential building for a sustainable period of time.

With the cleaning device of the present disclosure, the contact area between the cleaning device and the surface may be significantly increased, which may improve cleaning efficiency of a surface.

From the above description, it is manifested that various techniques can be used for implementing the concepts described in the present disclosure without departing from the scope of those concepts. Moreover, while the concepts have been described with specific reference to certain embodiments, a person of ordinary skill in the art may recognize that changes can be made in form and detail without departing from the scope of those concepts. As such, the described embodiments are to be considered in all respects as illustrative and not restrictive. It should also be understood that the present disclosure is not limited to the particular embodiments described above, but many rearrangements, modifications, and substitutions are possible without departing from the scope of the present disclosure.

1. A cleaning device for cleaning a surface, the cleaning device comprising:
a container;
a main cleaning component comprising a first rotatable conveyor belt; and
a guiding component in front of the main cleaning component along a moving direction of the cleaning device, the guiding component comprising a second rotatable conveyor belt, wherein:
the first and second conveyor belts rotate in opposite directions to remove an object from the surface and move the object toward the container when the cleaning device reaches the object on the surface.

2-4. (canceled)

5. The cleaning device of claim 1, wherein the first conveyor belt rotates clockwise while the second conveyor belt rotates counterclockwise.

6. The cleaning device of claim 1, wherein:
the main cleaning component further comprises at least one roller and at least one plane forming member,
the at least one roller and the at least one plane forming member are spaced apart laterally or spaced apart from each other along a height of the cleaning device, and
the first conveyor belt rotatably surrounds the at least one roller and the at least one plane forming member.

7. The cleaning device of claim 1, wherein:
the guiding component further comprises at least one roller and at least one plane forming member,
the at least one roller and the at least one plane forming member are spaced apart laterally or spaced apart from each other along a height of the cleaning device, and
the second conveyor belt rotatably surrounds the at least one roller and the at least one plane forming member.

8. The cleaning device of claim 6, wherein:
the at least one plane forming member comprises two plane forming members that cause a bottom portion of the first conveyor belt near the surface to form a plane that presses against the surface, and
the at least one roller is positioned above the two plane forming members along the height of the cleaning device.

9-18. (canceled)

19. The cleaning device of claim 7, wherein at least one of the at least one plane forming member is positioned above the at least one roller along the height of the cleaning device.

20. The cleaning device of claim 7, wherein:
the at least one plane forming member comprises two plane forming members that are spaced apart laterally, and
the at least one roller is positioned above the two plane forming members along the height of the cleaning device.

21. The cleaning device of claim 20, wherein the two plane forming members and the at least one roller form the second conveyor belt as a triangular shape.

22-39. (canceled)

40. The cleaning device of claim 1, wherein the first and second conveyor belts are at least partially parallel and positioned at an angel relative to the surface.

41. (canceled)

42. The cleaning device of claim 1, wherein:
the first conveyor belt has a top side and a bottom side, and
the bottom side of the first conveyor belt forms a first plane that presses against the surface.

43. The cleaning device of claim 42, wherein a surface area of the first plane is greater than a surface area of the top side of the first conveyor belt.

44. The cleaning device of claim 42, wherein the first plane presses against the surface partially due to a weight of the main cleaning component and partially due to a weight shifting of the guiding component onto the main cleaning component.

45. The cleaning device of claim 42, wherein:
the second conveyor belt has a bottom side comprising a second plane, and
an area of the first plane is greater than an area of the second plane.

46. The cleaning device of claim 45, wherein the second plane also presses against the surface.

47. The cleaning device of claim 46, wherein:
the first plane presses against the surface such that the first plane is entirely in contact with the surface, and
the second plane presses against the surface such that the second plane is partially in contact with the surface.

48. The cleaning device of claim 1, wherein the second conveyor belt is configured to direct the object on the surface toward the first conveyor belts and, while acting in concert with the first conveyor belt, toward the container.

49. The cleaning device of claim 1, wherein:
a bottom side of the second conveyor belt forms an induction slope near the surface,
the induction slope extends in a direction away from the first conveyor belt and from the surface, and
the induction slop of the second conveyor belt causes objects having different sizes to be driven toward the first conveyor belt.

50. The cleaning device of claim 1, wherein the second conveyor belt is longer than the first conveyor belt and rotates in the opposite direction of the first conveyor belt.

51. The cleaning device of claim 1, further comprising a drying component that is positioned behind the main cleaning component along a moving direction of the cleaning device, the drying component configured to dry at least one of the surface and the main cleaning component, wherein the drying component comprises at least a scraper and a drive unit for moving the scraper.

52. (canceled)

53. The cleaning device of claim 51, wherein the drive unit moves the scraper down to scrape the surface when the surface comprises a first type of surface and moves the scraper up to retract the scraper from contacting the surface when the surface comprises a second type of surface, and the first type of surface comprises a smooth surface and/or a flat surface and the second type of surface comprises a rough surface and/or an uneven surface.

54-184. (canceled)
